(19) United States
(12) Patent Application Publication
(10) Pub. No.: US 2016/0164690 A1
(43) Pub. Date: Jun. 9, 2016

(54) COMMUNICATION SYSTEM

(71) Applicant: NEC CORPORATION, Tokyo (JP)

(72) Inventor: Misao FUKUDA, Tokyo (JP)

(21) Appl. No.: 14/906,628

(22) PCT Filed: Jul. 9, 2014
(86) PCT No.: PCT/JP2014/003629

§ 371 Date: Jan. 21, 2016

(30) Foreign Application Priority Data
Jul. 23, 2013 (JP) 2013-152439

(51) Int. Cl. H04L 12/14; H04L 12/717; H04L 12/751

(52) U.S. Cl. CPC H04L 12/1403; H04L 12/1485; H04L 45/02; H04L 45/42

(57) ABSTRACT

In a state that: a plurality of segments are formed; the segments each include a communication path instruction device instructing establishment of a communication path in a network, the network in which a communication path is established by the communication path instruction device, and an information acquisition unit acquiring network information of the network; and networks of the respective segments are connected to each other via a network connection device, a communication path passing through a plurality of networks is established and a fee depending on the established communication path passing through the networks is determined.

### TECHNICAL FIELD

The present invention relates to a communication system, an information processing device, a charging method, and a program. More specifically, the present invention relates to a communication system controlling a wide-range network, an information processing device, a charging method, and a program.

### BACKGROUND ART

Big data has been getting attention in recent years. As symbolized by such big data, with development of information and communications technology, communication of a huge amount of data is performed on the Internet, for example.

In order to handle communication of a huge amount of data, telecommunications carriers providing communication services need to invest in facilities for communication. A known facility (technique) as the target of investment is a facility (technique) as described in Patent Document 1, for example.
Patent Document 1: Japanese Unexamined Patent Application Publication No. JP-A 2000-278314

However, according to the technique mentioned above, telecommunications carriers also need to perform management of WANs after investment in facilities. Therefore, telecommunications carriers also need to invest in management of the facilities, and need to invest huge amounts of money. Moreover, although telecommunications carriers need to reduce communication fees in order to take customers from competitors, the huge facility investment has been a drag thereon and has prevented telecommunications carriers from reducing communication fees sufficiently.

Thus, there is a problem that telecommunications carriers need to invest huge amounts in facilities because they need to not only invest in communication facilities in order to handle a large amount of data but also manage the facilities (WANs) invested thereby by themselves. Moreover, there is a problem that telecommunication carriers cannot sufficiently reduce customers' communication fees because they need to invest large amounts of money.

### SUMMARY

Accordingly, an object of the present invention is to provide a communication system which can solve the abovementioned problem that telecommunications carriers need to invest huge amounts in facilities because they need to manage the facilities (WANs) invested thereby by themselves.

In order to achieve the object, in a communication system as an aspect of the present invention:

a plurality of segments are formed;

the plurality of segments each include: a communication path instruction device instructing establishment of a communication path in a network; the network in which a communication path is established by the communication path instruction device; and an information acquisition unit acquiring network information of the network; and

networks of the respective segments are connected to each other via a network connection device.

The communication system includes:

an information aggregation unit aggregating a plurality of the network information acquired by information acquisition units of the respective segments;

a higher-level communication path instruction unit instructing establishment of a communication path passing through a plurality of networks in the networks of the respective segments by using the information aggregated by the information aggregation unit; and,

a charging unit determining a charged fee on a predetermined basis depending on the communication path passing through the plurality of networks, the communication path being established on instruction by the higher-level communication path instruction unit.

Further, an information processing device as another aspect of the present invention is used in a state that:

a plurality of segments are formed;

the plurality of segments each include: a communication path instruction device instructing establishment of a communication path in a network; the network in which a communication path is established by the communication path instruction device; and an information acquisition unit acquiring network information of the network; and

networks of the respective segments are connected to each other via a network connection device.

The information processing device includes a charging unit determining a charged fee on a predetermined basis depending on a communication path passing through a plurality of the networks, the communication path being established by using information obtained by aggregating a plurality of the network information acquired by information acquisition units of the respective segments.

Further, a charging method as another aspect of the present invention is a charging method in a state that:

a plurality of segments are formed;

the plurality of segments each include: a communication path instruction device instructing establishment of a communication path in a network; the network in which a communication path is established by the communication path instruction device; and an information acquisition unit acquiring network information of the network; and

networks of the respective segments are connected to each other via a network connection device.

The charging method includes:

aggregating the network information from the networks of the respective segments;

instructing establishment of a communication path passing through a plurality of the networks by using the aggregated network information; and

determining a charged fee on a predetermined basis depending on the communication path passing through the networks.

Further, a program as another aspect of the present invention is a computer program in a state that:

a plurality of segments are formed;

the plurality of segments each include: a communication path instruction device instructing establishment of a communication path in a network; the network in which a communication path is established by the communication path instruction device; and an information acquisition unit acquiring network information of the network; and

networks of the respective segments are connected to each other via a network connection device,

The computer program includes instructions for causing an information processing device to realize a charging unit determining a charged fee on a predetermined basis depending on a communication path passing through a plurality of networks, the communication path being established by using information obtained by aggregating a plurality of the network information acquired by information acquisition units of the respective segments.

With the configurations as described above, the present invention eliminates the need for management of WANs by telecommunications carriers and therefore enables reduction of investment in communication facilities by the telecommunication carriers.

### BRIEF DESCRIPTION OF DRAWINGS

FIG. 1 is a diagram showing the configuration of a communication system in a first exemplary embodiment of the present invention;

FIG. 2 is a diagram showing the configuration of a segment 1 in the first exemplary embodiment;

FIG. 3 is a block diagram showing the function of an information processing unit in the first exemplary embodiment of the present invention;

FIG. 4 is a block diagram showing the configuration of a virtual machine control part shown in FIG. 3;

FIG. 5 is a block diagram showing the configuration of each terminal device shown in FIGS. 1 and 2;

FIG. 6 is a block diagram showing the configuration of an OpenFlow switch shown in FIGS. 1 and 2;

FIG. 7 is a diagram illustrating a flow table used by the OpenFlow switch;

FIG. 8 is a block diagram showing the configuration of an external WAN server shown in FIG. 1;

FIG. 9 is a block diagram showing the configuration of a higher-level information processing unit shown in FIG. 1;

FIG. 10 is a block diagram showing the configuration of a fee management function part shown in FIG. 9;

FIG. 11 is a flowchart showing processing operation by the OpenFlow switch;

FIG. 12 is a sequence diagram illustrating address resolution by the information processing unit;

FIG. 13 is a sequence diagram illustrating a flow entry acquisition process by an OpenFlow controller function part;

FIG. 14 is a flowchart illustrating the flow entry acquisition process shown in FIG. 13;

FIG. 15 is a flowchart illustrating the operation of decision of a fee by a fee management determination part;

FIG. 16 is a diagram showing the configuration of a communication system in a second exemplary embodiment;

FIG. 17 is a diagram showing the configuration of a communication system in a third exemplary embodiment;

FIG. 18 is a block diagram showing the configuration of an external WAN server in the third exemplary embodiment;

FIG. 19 is an example of path selection by a segment selection function part shown in FIG. 18;

FIG. 20 is a diagram showing with arrows the flow of information in the third exemplary embodiment;

FIG. 21 is a diagram showing with arrows the flow of information in the third exemplary embodiment; and

FIG. 22 is a block diagram showing the configuration of a higher-level information processing unit in a fifth exemplary embodiment.

### EXEMPLARY EMBODIMENTS

### First Exemplary Embodiment

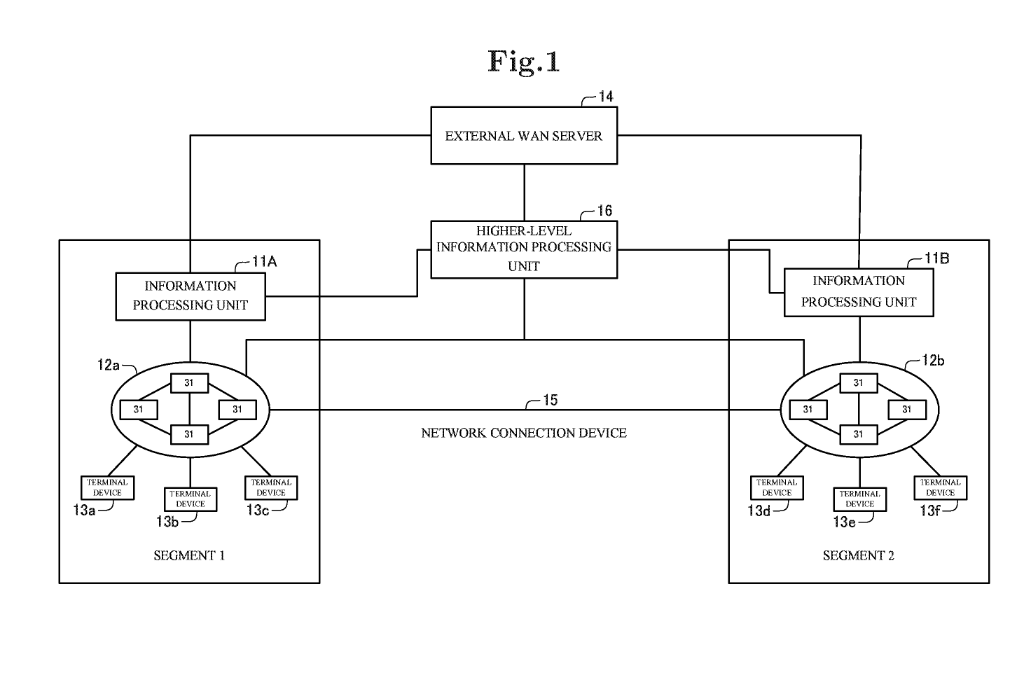

A first exemplary embodiment of the present invention will be described with FIGS. 1 to 15.

The present invention utilizes OpenFlow technology for the purpose of solution of the abovementioned problem that telecommunications carriers need to manage WANs by themselves. Then, a charging function is included so that a provider or the like other than a carrier can handle management of WANs.

The number of OpenFlow switches (network devices) which a single OpenFlow controller (a communication path instruction device) can manage is limited. Thus, a range in which a single OpenFlow controller manages will be referred to as a segment. The first exemplary embodiment shows a case of two segments. That is, a case where there are two segments and establishment of a communication path across the two segments is required will be described.

### (Configuration)

As shown in FIG. 1, a communication system in this exemplary embodiment is configured by two segments (a segment 1 and a segment 2), an external WAN server 14 (an information aggregation unit), and a higher-level information processing unit 16 (a higher-level communication path instruction unit). The external WAN server 14 is located outside the two segments. In this exemplary embodiment, management of the external WAN server 14 is performed by a telecommunications carrier. Moreover, the higher-level information processing unit 16 is also located outside the two segments, and is managed by a provider other than the carrier managing the WAN server 14. With the configuration described above, the present invention enables a provider other than a telecommunications carrier to manage a WAN by using WAN information managed by the telecommunications carrier. Further, the networks within the respective segments to be described later are connected by a network connection device 15. This exemplary embodiment shows the case of two segments, but the present invention can be practiced independent of the number of segments.

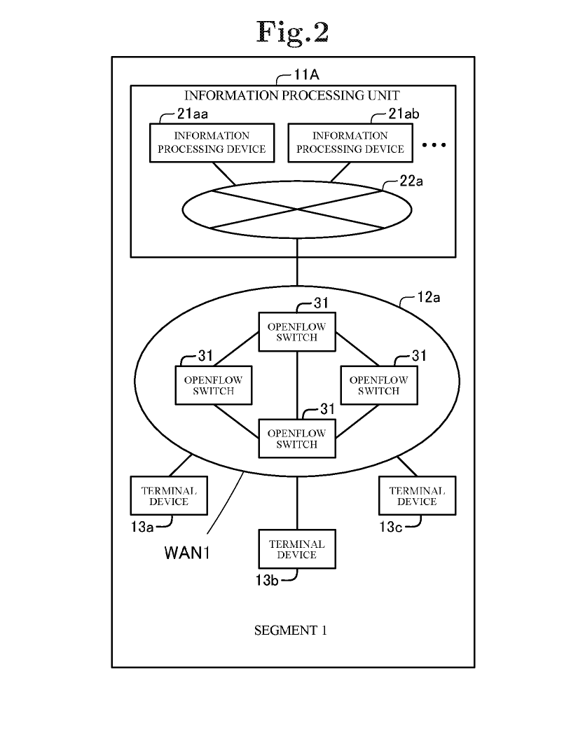

Next, the configuration of the inside of the segment 1 will be described with FIG. 2.

As shown in FIG. 2, the segment 1 is configured by an information processing unit 11A, a network 12a including a plurality of OpenFlow switches 31 which can be mutually connected, and terminal devices 13.

First, the information processing unit 11A will be described. The information processing unit 11A serves as an OpenFlow controller in this exemplary embodiment. To be specific, the information processing unit 11A includes a plurality of information processing devices 21aa, 21ab, . . . (hereinafter, the information processing devices will be each referred to as an information processing device 21 when not distinguished from each other; it is also true for other components). The information processing devices 21 are connected so as to be capable of communicating via a network 22a within the information processing unit 11A. In this exemplary embodiment, each of the information processing devices 21 is made up by a blade server. The information processing unit 11A includes a plurality of information processing devices 21 in the above description, but may be made up by a single information processing device 21 (e.g., the information processing device 21aa). That is to say, the single information processing device 21 may have a configuration for realizing each function part of the information processing unit 11 to be described later.

Each of the information processing devices 21 is configured to be capable of building a plurality of virtual machines (virtual servers). To be specific, each of the information processing devices 21 executes a program serving as a main operating system (a main OS). Then, each of the information processing devices 21 executes, on the main OS, a virtual machine program serving as a program for making the virtual machines work. Additionally, each of the information processing devices 21 executes at least one subsidiary OS (a guest OS) on the virtual machine program. Moreover, each of the information processing devices 21 executes at least one application program on each guest OS. The guest OS executed by each of the information processing devices 21 makes up a virtual machine. Each virtual machine implements one of function parts to be described later.

Next, the terminal devices 13 will be described. Each of the terminal devices 13 (terminal devices 13a, 13b, 13c, . . . shown in FIG. 2) is, for example, a personal computer or a smartphone. Each of the terminal devices may be a mobile phone terminal, a PHS (Personal Handy-phone System), a PDA (Personal Data Assistance, Personal Digital Assistant), a car navigation terminal, a game terminal, or the like.

In this exemplary embodiment, the terminal device 13 is connected, via the network 12a (e.g., WAN (Wide Area Network)) within the segment 1, to the network 22a which is within the information processing unit 11A placed in the segment 1 and is different from the network 12a. Although a case where three terminal devices 13 are connected to the network 12a is illustrated in FIG. 2, the present invention can be practiced independent of the number of the terminal devices 13. The present invention may be practiced even if only one terminal device 13 is connected to the network, or even if four or more terminal devices 13 are connected to the network.

Next, the network 12a will be described. The network 12a includes a plurality of OpenFlow switches 31 which can be mutually connected. The network 12a is a different network from the network 22a within the information processing unit 11A. The network 12a is connected to the network 22a. The network 12a and the network 22a are connected by a communication network such as the IP (Internet Protocol) network.

The configuration of the inside of the segment 1 has been described above. Meanwhile, the inside of the segment 2 is also configured as the inside of the segment 1. That is to say, the segment 2 is configured by an information processing unit 11B, a network 12b, and terminal devices 13. However, the segments 1 and 2 may be different in number of components configuring the respective segments. For example, the segments 1 and 2 may be different in number of the terminal devices 13.

Further, as shown in FIG. 1, the network 12a and the network 12b within the segment 2 are connected to each other by the network connection device 15 as shown in FIG. 1. The network connection device 15 is, for example, a high-capacity switch. To be specific, the network 12a and the network 12b are connected by one high-capacity switch 15 in a case where the segment 1 and the segment 2 belong to the same telecommunications carrier, whereas the network 12a and the network 12b are connected by two high-capacity switches 15 in a case where the segment 1 and the segment 2 belong to different telecommunication carriers from each other.

Further, the external WAN server 14 (an information aggregation unit) shown in FIG. 1 is placed outside, not belonging to any of the two segments as stated above. For example, the external WAN server 14 is placed on the cloud. In this exemplary embodiment, a telecommunications carrier manages the external server 14.

The external WAN server 14 is a server which aggregates information of the networks (12a and 12b) acquired by administrator function parts 42 (information acquisition units) included by the respective information processing units 11A and 11B to be described later.

Although an external server (the external WAN server 14) is used as the information aggregation unit in this exemplary embodiment, there is no need to always use an external server in the practice of the present invention. For example, the administrator function part 42 within one information processing unit 11 may acquire network information from the administrator function part 42 of another segment as necessary.

The higher-level information processing unit 16 (a higher-level communication path instruction unit) is a unit which executes establishment of a communication path to be described later on the segments 1 and 2 by using the information within the external WAN server 14. The higher-level information processing unit 16 is placed outside the segments 1 and 2 as the external WAN server 14 is and, in this exemplary embodiment, is managed by a provider other than the telecommunications carrier managing the external WAN server 14.

As stated above, a range in which a single information processing unit 11 instructs establishment of a communication path is limited. Therefore, a range in which a single information processing unit 11 instructs establishment of a communication path is defined as a segment. Because a range in which a single information processing unit 11 instructs establishment of a communication path is a defined as a segment, one segment has only information for establishing a communication path in the segment. That is to say, the information processing unit 11A within the segment 1 does not have information for establishing a communication path in the segment 2, and consequently, the information processing unit 11A cannot establish a communication path via the segments 1 and 2. This is true for the information processing unit 11B. Thus, the higher-level information processing unit 16 has a role of instructing establishment of a communication path via the segments 1 and 2 mentioned above. Further, as the higher-level information processing unit 16 has a role in establishment of a communication path via a plurality of segments, the telecommunications carrier does not need to control establishment of a communication path via segments in communicating via segments. As a result, the telecommunications carrier does not need to invest in a facility and so on for the control (management), and suppression of investment in a communication facility can be expected. In this exemplary embodiment, a provider other than a telecommunications carrier manages a higher-level information processing unit. However, the present invention can be practiced, not limited to the abovementioned case.

Next, the detailed configuration of this exemplary embodiment will be described.

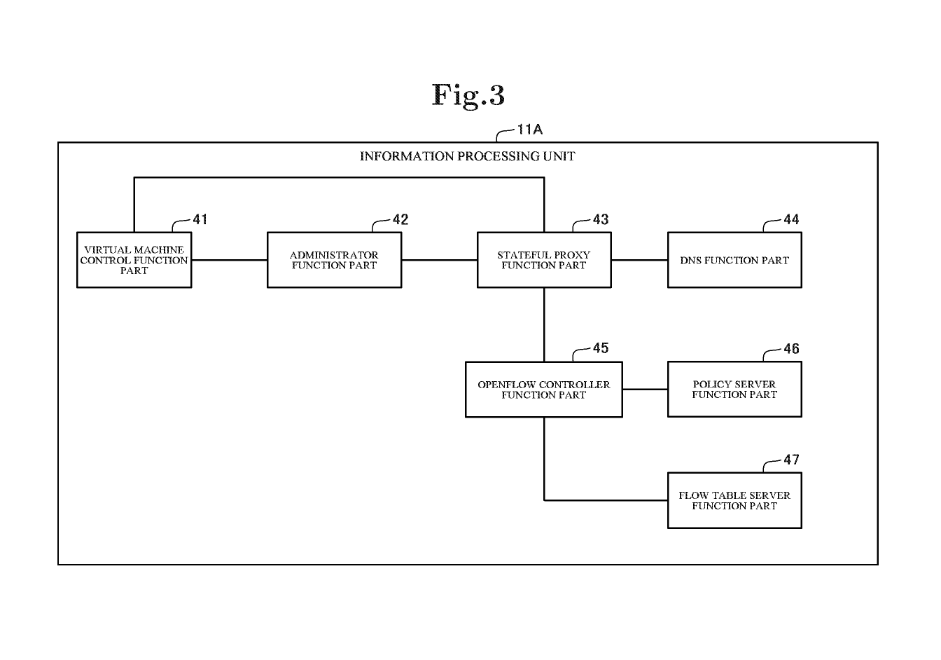

First, referring to FIG. 3, the configuration of the information processing unit 11A will be described. As shown in FIG. 3, the information processing unit 11A has a virtual machine control function part 41, an administrator function part 42 (an information acquisition unit), a stateful proxy function part 43, a DNS (Domain Name (Naming) System (Server)) function part 44, an OpenFlow controller function part 45 (a communication path instruction device), a policy server function part 46 (the communication path instruction device), and a flow table server function part 47 (the communication path instruction device). The respective function parts (e.g., the OpenFlow controller function part 45) within the information processing unit 11A may be configured by a single information processing device 21, or may be configured by a plurality of information processing devices 21. Moreover, as stated above, the configuration of the information processing unit 11B is identical to the configuration of the information processing unit 11A.

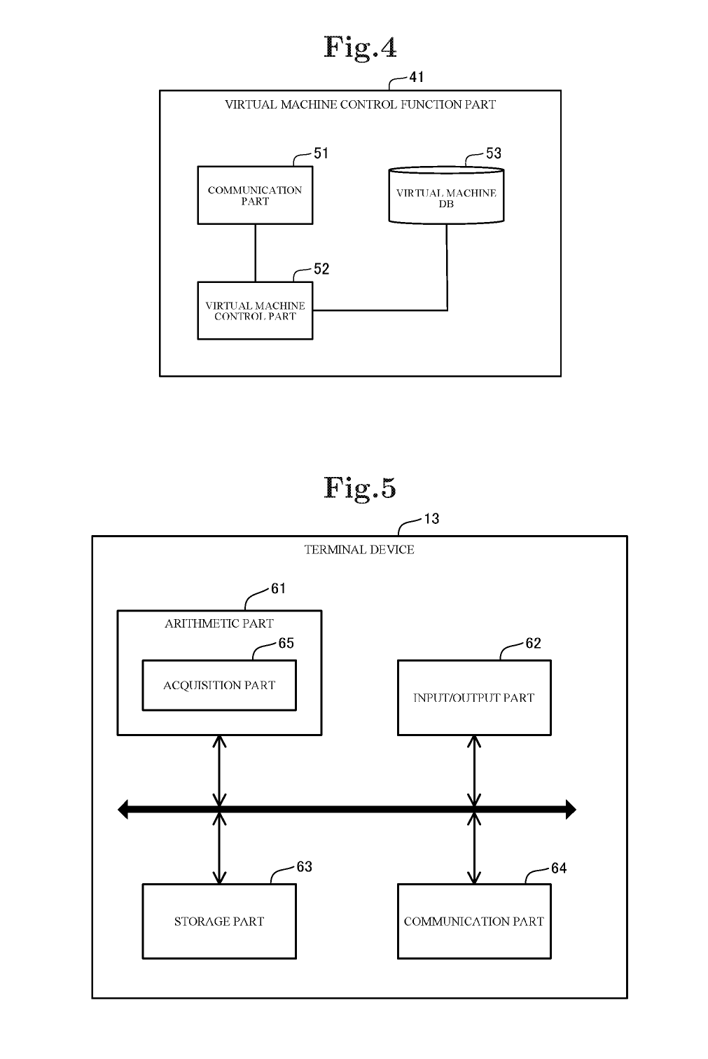

The virtual machine control function part 41 is a part which generates and controls a virtual machine within the information processing unit 11 and a virtual machine for the terminal device 13. To be specific, as shown in FIG. 4, the virtual machine control function part 41 includes a communication part 51, a virtual machine control part 52, and a virtual machine DB (DataBase) 53. Further, the virtual machine control function part 41 receives terminal identification information transmitted from the terminal devices 13 to be described later, and recognizes a terminal accessing the information processing unit 11.

The administrator function part 42 is a part which monitors a network controlled thereby (a network within the same segment). For example, every time the network managed by the administrator function part 42 is changed, the administrator function part 42 sends information about that to the external WAN server 14 to be described later. Information transmitted by the administrator function part 42 is, for example, topology information, flow table information, and so on. Various kinds of information can be acquired from the controlled network. In this exemplary embodiment, the administrator function part 42 of each of the segments acquires topology information, flow table information and so on of the network (12a, 12b) to which the administrator function part 42 belongs, and transmits the acquired information to the external WAN server 14. Further, upon figuring out that communication passing through a plurality of segments is intended, the administrator function part 42 transmits communication destination information and transfer setting information, which will be described later, acquired by the administrator function part 42 to the external WAN server 14 in order to calculate a path passing through the plurality of segments. Furthermore, the administrator function part 42 also has a role of transmitting a setting completion notice of an OpenFlow switch to be described later to the external WAN server 14 via the administrator function part 42. Transmission and reception of information by the administrator function part 42 and the external WAN server 14 enables calculation of a path passing through a plurality of segments.

The stateful proxy function part 43 and the DNS function part 44 are configured by, for example, a SIP (Session Initiation Protocol) server. The stateful proxy function part 43 and the DNS function part 44 are parts which control connection between a plurality of user terminals. For example, in executing address resolution within the same segment, the stateful proxy server function part 43 and the DNS function part 44 are used. To be specific, upon acquiring communication destination information to be described later, the stateful proxy function part 43 transfers the acquired communication destination information to the DNS function part 44. Then, the DNS function part 44 acquires a communication destination address (e.g., an IP address) stored in association with the received communication destination information, and transfers the communication destination address to the stateful proxy function part 43. Through the operation described above, address resolution to be described later is executed. Besides, the stateful proxy function part 43 works, for example, when network resolution to be described later is executed.

The OpenFlow controller function part 45 is a part which designs a communication path in the network 12a. That is to say, the OpenFlow controller function part 45 executes a communication path instruction process, which is instructing the OpenFlow switches 31 placed within the network 12a to establish a communication path in the network 12a. To be specific, in a case where a new process becomes necessary, for example, in a case where a process which cannot be handled with flow tables stored in the OpenFlow switches 31 to be described later becomes necessary, the OpenFlow controller function part 45 uses transfer setting information and so on to generate a flow entry which is necessary when the OpenFlow switches 31 transfer information.

The policy server function part 46 is a part which stores policy information for setting a path within the network 12a. Policy information is a rule for ensuring information security in an organization such as a company. Policy information includes information such as ID, port number, access restriction, and connection destination which preferentially connects.

The flow table server function part 47 is a part which stores a flow entry for giving a path to the OpenFlow switches 31. The flow entry generated by the OpenFlow controller function part 45 described above is managed by the flow table server function part 47.

With the configuration described above, the information processing unit 11A realizes the function of the OpenFlow controller on the cloud. Further, the information processing unit 11A provides a thin client environment (e.g., DaaS (Desktop as a Service)) via the virtual machine control function part 41 to the terminal device 13 accessing the information processing unit 11A. That is to say, all the processing by the OpenFlow controller is executed on the information processing unit 11A, and therefore, the terminal device 13 accessing the information processing unit 11A can perform communication using a path obtained by path calculation, without executing processing on the terminal device 13.

Next, the configuration of the terminal device 13 will be described with FIG. 5. As stated above, the terminal device 13 utilizes a virtual machine provided by the virtual machine control function part 41. As shown in FIG. 5, the terminal device 13 includes an arithmetic part 61, an input/output part 62, a storage part 63, and a communication part 64. The arithmetic part 61 has a function of an acquisition part 65 by executing a program previously stored in the storage part 63. The acquisition part 65 has a function of acquiring terminal identification information. When the acquired terminal identification information is transmitted to the virtual machine control function part 41 through the communication part 64, the virtual machine control function part 41 thereby authenticates the terminal device 13. As stated above, the terminal device 13 is a device which utilizes a thin client environment (e.g., DaaS (Desktop as a Service) provided by the virtual machine control function part 41. Therefore, the terminal device 13 may include at least the arithmetic device 61 such as a CPU (Central Processing Unit), the input/output device 62, and the communication part 64.

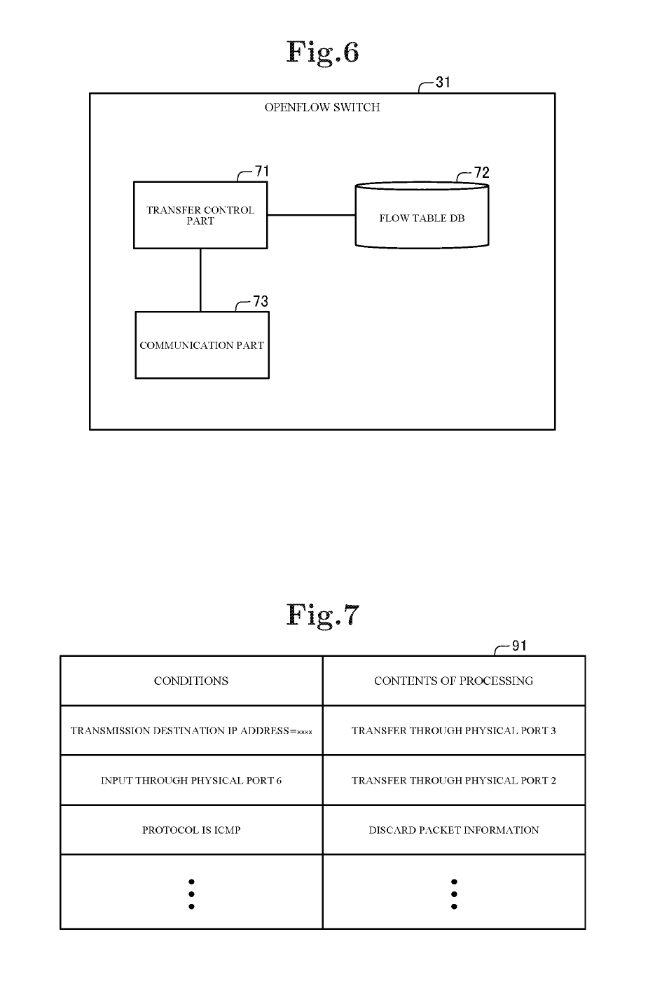

Next, referring to FIG. 6, the configuration of the OpenFlow switch 31 will be described. As shown in FIG. 6, the OpenFlow switch 31 includes a transfer control part 71, a flow table DB 72, and a communication part 73. A flow table stored in the flow table DB 72 is information stored when a preset communication path instruction process is executed by the OpenFlow controller function part 45. The transfer control part 71 is a part which transfers packet information on the basis of the flow table stored in the flow table DB 72. The communication part 73 is used in contacting the information processing unit 11 to be described later or in transmitting a setting completion notice to be described later. That is to say, the OpenFlow switch 31 exchanges various kinds of information to be described later with the information processing unit 11A via the communication part 73.

FIG. 7 is a diagram showing an example of a flow table 91 stored in the flow table DB 72. As shown in FIG. 7, “conditions” are associated with “contents of processing” in the flow table 91. Each row in the flow table 91 shows a flow entry. In the example shown in FIG. 7, when receiving packet information that a transmission destination IP address is “xxxx,” the transfer control part 71 transfers (transmits) the received packet information through a physical port 3. Further, when there is an entry of packet information through a physical port 6 of the OpenFlow switch 31, the transfer control part 71 transfers the packet information through a physical port 2. Furthermore, in a case where a protocol included in received packet information is “ICMP (Internet Control Message Protocol,” the transfer control part 71 discards the received packet information. Thus, the transfer control part 71 executes a transfer process based on each flow entry of the flow table 91, and therefore, can transfer packet information quickly and easily.

On the other hand, when a flow entry corresponding to information to be transferred is not stored, the OpenFlow switch 31 contacts the information processing unit 11A having the function of the OpenFlow controller to know how to handle. When contacted, the information processing unit 11A generates a flow entry through operation to be described later, and transmits the flow entry to the OpenFlow switch 31. Upon receiving the flow entry, the OpenFlow switch 31 sets the flow entry into the flow table (transfer setting). Then, when transfer setting is complete, the OpenFlow switch 31 transmits a setting completion notice to the external WAN server 14 via the administrator function part 42 within the information processing unit 11A.

After receiving setting completion notices from all the OpenFlow switches 31 that are the target of setting, the external WAN server 14 sends a communication start instruction to a terminal which is to perform communication and the OpenFlow switch 31 to be used in the communication, via the administrator function part 42 within the information processing unit 11A. That activity allows the OpenFlow switch 31 to be used in communication to properly process packets to be transmitted in the communication.

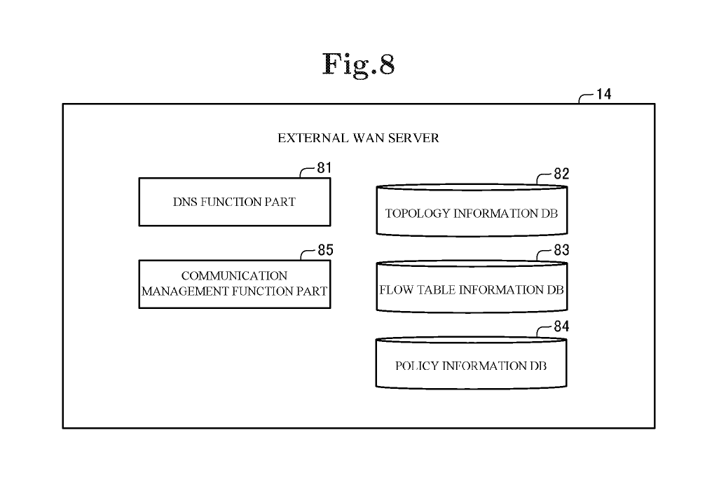

Next, referring to FIG. 8, the external WAN server 14 will be described. The external WAN server 14 is a server which aggregates information of the segments 1 and 2. In this exemplary embodiment, as stated above, the external WAN server 14 is placed outside, not belonging to either the segment 1 or the segment 2. As described later, the higher-level information processing unit 16 calculates a path across the segments by using the information aggregated by the external WAN server 14. Therefore, the external WAN server 14 is structured so as to be capable of storing information which is necessary when the higher-level information processing unit 16 executes path calculation. Further, as stated above, the external WAN server 14 is configured to have a function of receiving setting completion notices from the respective OpenFlow switches 31 and instructing start of communication.

To be specific, as shown in FIG. 8, the external WAN server 14 includes a DNS function part 81, a topology information DB (database) 82, a flow table information DB 83, a policy information DB 84, and a communication management function part 65.

The DNS function part 81 is a part which executes address resolution across segments at the time of communication across segments. Address resolution will be described later. The communication management function part 85 is a part which receives setting completion notices from the respective OpenFlow switches 31 to which the information processing unit 11A has transmitted flow entries because transfer setting is required as described above. Then, upon receiving setting completion notices from all the OpenFlow switches that are the target of transfer, the communication management function part 85 sends a communication start instruction to the administrator function part 42 included by the information processing unit within the segment which is the source of communication. Further, as described later, information about the networks of the respective segments collected by the administrator function parts 42 within the respective segments is aggregated in each of the databases.

Below, the respective DBs (databases) will be described in detail. The topology information DB 82 is a database which stores topology information. Topology information is information of a network connection form, such as what switch connects to what port of an OpenFlow switch located in each segment. The flow table information DB 83 is a database which stores a flow table used at the time of processing information received by an OpenFlow switch within each segment described above. The policy information DB 84 is a database which stores a security policy in each segment such as access priority. As stated above, the information processing unit 11A calculates a path across a plurality of segments by using the information stored in the respective databases. In this exemplary embodiment, the external WAN server 14 is configured by a single device. However, in the present invention, the external WAN server 14 does not need to be always realized by a single device. For example, the function of the external WAN server 14 may be realized by a plurality of devices which are distributed on the cloud.

An external storage device may be connected to the external WAN server 14 via a communication line which allows mutual communication. The external storage device includes a DNS DB, a topology information DB, a flow table DB, and a policy information DB. Every time information about DNS, topology information, flow table information or policy information stored in the external WAN server 14 connected to the external storage device is updated, the external storage device replicates and stores the information. Connection of the external storage device replicating and storing the information stored in the external WAN server 14 makes it possible to, for example, even if any trouble occurs in the external WAN server 14, handle without any problem.

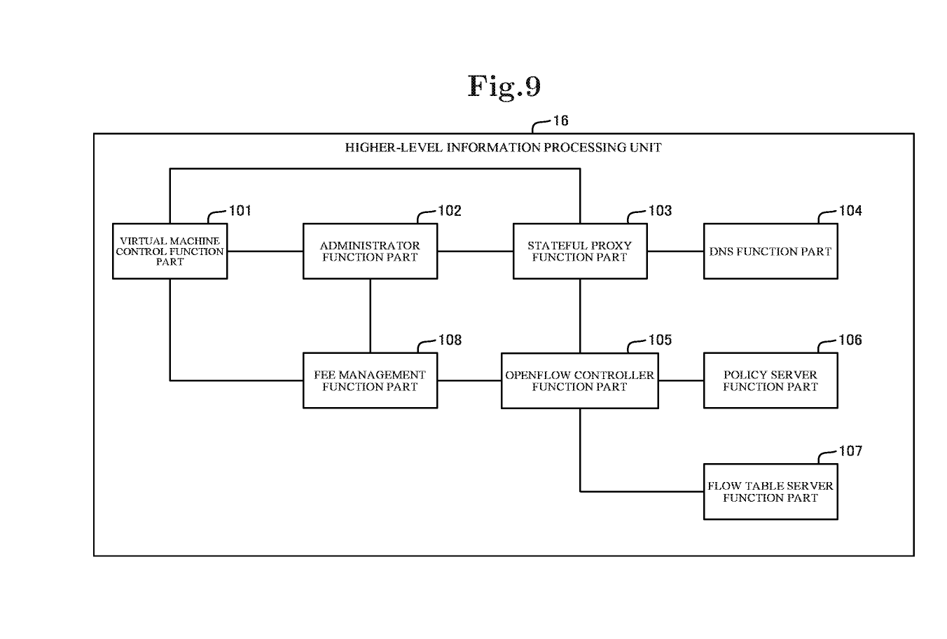

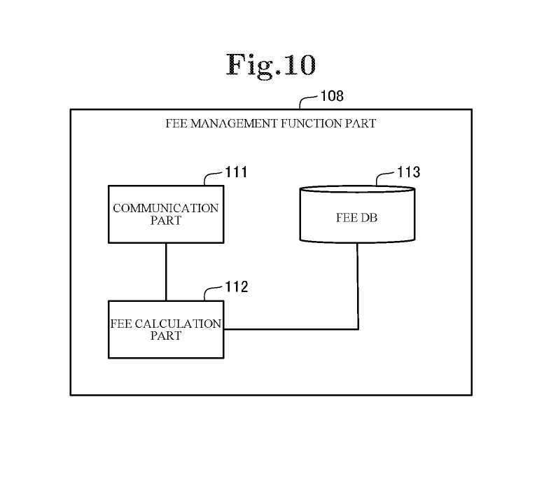

Next, the higher-level information processing unit 16 will be described with FIG. 9. As shown in FIG. 9, in this exemplary embodiment, the higher-level information processing unit 16 has the same configuration as the information processing units 11A and 11B. That is to say, the higher-level information processing unit 16 includes a virtual machine control function part 101, an administrator function part 102, a stateful proxy function part 103, a DNS function part 104, an OpenFlow controller function part 105, a policy server function part 106, and a flow table server function part 107. The configuration of each of the function parts is the same as that of the information processing units 11A and 11B. Moreover, the higher-level information processing unit 16 includes a fee management function part 108 (a charging unit). Furthermore, the higher-level information processing unit 16 may include a communication service DB, which is not shown in the drawings.

In this exemplary embodiment, the higher-level information processing unit 16 receives information of the inside of the segments 1 and 2 via the external WAN server 14, and establishes a communication path passing through the segments 1 and 2 by using the information received via the external WAN server 14. Therefore, the higher-level information processing unit 16 does not need to include the policy server function part 106 or the flow table server function part 107 to execute path calculation by using policy information and so on stored therein. Further, in this exemplary embodiment, the higher-level information processing unit 16 acquires information (e.g., internal transfer setting information to be described later) of establishment of a communication path, via the information processing unit 11A managing the segment 1. However, the present invention is not limited to the abovementioned case. For example, the higher-level information processing unit 16 may be configured to directly receive internal transfer setting information from the OpenFlow switches 31 within the network 12a.

Next, the communication service DB will be described. The communication service DB stores communication service information showing the content of a communication service previously associated with the terminal identification information of the terminal device 13 described above (or previously associated with each user determined on the basis of the terminal identification information). The communication service information is throughput information of a communication path, quality information such as image quality and sound quality, information of the allowable degree of delay, security additional information, or the like. In a case where the higher-level information processing unit 16 includes the communication service DB, the OpenFlow controller function part 105 can establish a communication path in consideration of the communication service information stored in the communication service DB as well.

Next, the fee management function part 108 will be described. As shown in FIG. 10, the fee management function part 108 includes a communication part 111, a fee calculation part 112, and a fee DB 113. The communication part 111 is a part which communicates with the outside (e.g., the external WAN server 14 or the OpenFlow controller function part 105). The fee calculation part 112 is a part which calculates a charged fee by associating information acquired by the communication part 111 with information stored in the fee DB corresponding to the information acquired by the communication part 111. The fee DB 113 is a part which stores the amounts of money for determining a charged fee, on the basis of various conditions. For example, the fee DB 113 stores information how much a fee increases as the number of segments passed through increases, how much a fee changes on the basis of communication service information, and so on.

As stated above, the fee management function part 108 is a part which determines a charged fee on a predetermined basis in accordance with a communication path established by the higher-level information processing unit 16. Therefore, the fee management function part 108 collects information necessary for determining a charged fee via the communication part 111. To be specific, the fee management function part 108 collects information of the results of path calculation by the OpenFlow controller function part 105 via the communication part 111. Moreover, the fee management function part 108 collects topology information and so on of the inside of the segments 1 and 2. The fee management function part 108 may acquire topology information and so on of the inside of the segments 1 and 2 from the external WAN server 14 through the administrator function part 102, or may use topology information and so on used at the time of path calculation by the higher-level information processing unit 16. Further, in a case where a communication path has been established in consideration of communication service information held by the communication service DB as well, the fee management function part 108 may collect the communication service information. As stated above, the fee management function part 108 can acquire information necessary for determination of a charged fee. Then, the fee management function part 108 determines a fee to be charged by the fee calculation part 112 by using the information necessary for determining a charged fee acquired via the communication part 111 and the information stored in the fee DB 113.

To be specific, for example, the fee management function part 108 determines a charged fee depending on the number of segments through which a communication path established by the higher-level information processing unit 16 passes. In this case, as stated above, the fee management function part 108 receives the number of segments through which a communication path passes, via the communication part 111. In this exemplary embodiment, because a communication path passing through the segments 1 and 2 is established, the number of segments passed through is two. Then, the fee management function part 108 refers to information stored in the fee DB 113 in association with the number of segments=2, and determines a fee to be charged by the fee calculation part 112.

In this exemplary embodiment, the fee management function part 108 is realized as one function of the higher-level information processing unit. However, the practice of the present invention is not limited to such a case. For example, a device independent of the higher-level information processing unit 16 may include this function. Providing the independent device including the charging unit enables the higher-level information processing unit 16 to perform communication with the device and determine a charged fee every time determination of a charged fee is required. Further, this exemplary embodiment exemplifies an aspect of charging for every segment passed through. However, the charging unit in the present invention is not limited to the abovementioned case. For example, the fee management function part 108 may include a charge selection part which is not shown in the drawings so as to be capable of selecting from a plurality of fees, such as a form of charging a fee every time a segment is passed through as shown in this exemplary embodiment and a form of allowing use of the communication system for a given period (e.g., for one month) at a fixed rate. In this case, a form of charging in consideration of information stored in the communication service DB as well may be possible. Charging forms may include, for example, a form of charging no fee until exceeding SLA (SERVICE LEVEL AGREEMENT) stored in the communication service DB to some extent.

The detailed configuration of the communication system in the first exemplary embodiment has been described above. In this exemplary embodiment, the function of the OpenFlow controller is realized by the information processing units 11A and 11B, namely, a plurality of information processing units distributed on the cloud. However, it is not always necessary to realize the function of the OpenFlow controller on the cloud. Moreover, the external WAN server 14 does not need to be always placed on the cloud, which is different from the segments 1 and 2.

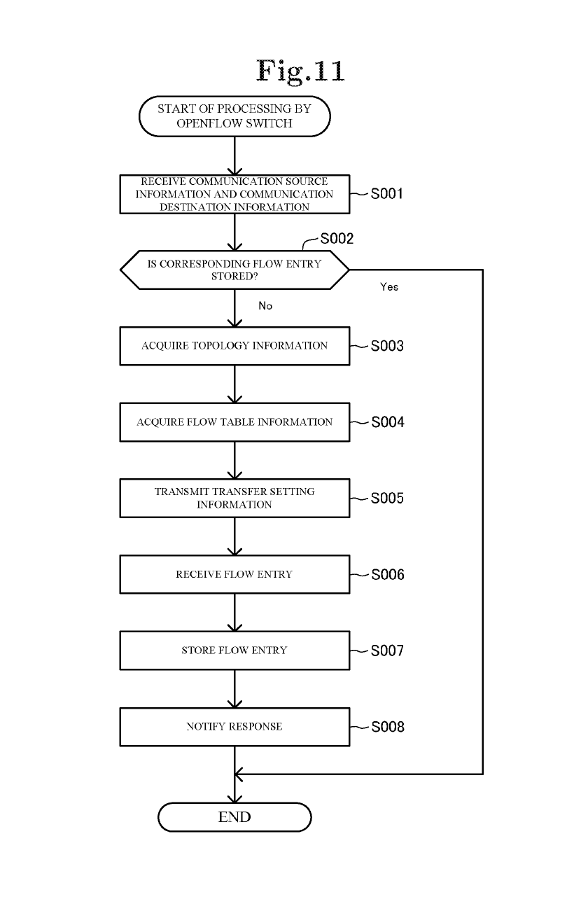

Next, referring to FIGS. 11 to 15, the operation of the communication system in this exemplary embodiment when there is a need to transmit information from the terminal device 13a in the segment 1 to the terminal device 13e in the segment 2 will be described.

In this exemplary embodiment, it is an assumption in operation to be described later that network information of the respective networks 12a and 12b within the segments 1 and 2 is aggregated by the external WAN server 14. To be specific, the administrator function parts 42 included by the information processing units 11A and 11B in the segments 1 and 2 monitor the networks 12a and 12b controlled by the respective administrator function parts 42 and, every time there is a change in the network 12a or 12b, transmit information about the change to the external WAN server 14. As mentioned above, information aggregated in this exemplary embodiment is topology information configured by connection information or the like of the respective OpenFlow switches, flow table information used when the OpenFlow switches in the respective segments transfer information, and policy information which is a security policy of each of the segments.

### (Operation)

First, upon starting communication, the terminal device 13a transfers communication source information (e.g., the IP address, MAC address and the like of the terminal device) and communication destination information (e.g., telephone number, e-mail address, URL and the like) to the OpenFlow switch 31 within the network 12a.

As shown in FIG. 11, upon receiving the communication source information and the communication destination information (step S001), the transfer control part 71 (see FIG. 6) of the OpenFlow switch 31 determines whether an associated flow entry is recorded on the flow table DB 72 (step S002). Then, in a case where an associated flow entry is recorded on the flow table DB 72, the OpenFlow switch 31 controls communication in accordance with the flow entry. On the other hand, in a case where an associated flow entry is not recorded, the OpenFlow switch 31 contacts the information processing unit 11A to know how to process. To be specific, the transfer control part 71 acquires topology information (information showing the connection state of another OpenFlow switch or the like connected to each port of the OpenFlow switch) and flow entry information (information of flow entries stored in the OpenFlow switch) (steps S003 and S004), and the transfer control part 71 transmits, as internal transfer setting information, the topology information and flow entry information mentioned above, the communication source information and the communication destination information to the administrator function part 42 included by the information processing unit 11A (step S005). After that, the OpenFlow switch 31 receives and stores a flow entry transmitted after a process to be described later (steps S006 and S007). Then, the OpenFlow switch 31 notifies completion of setting (step S008).

Upon acquiring the respective information described above, the administrator function part 42 figures out from the acquired information that communication of transmission from the terminal device 13a to the terminal device 13e is communication across the segments. Then, the administrator function part 42 adds policy information included in the policy server function part 46 to the abovementioned internal transfer setting information, and transmits the information to the higher-level information processing unit 16.

Upon receiving the internal transfer setting information, the higher-level information processing unit 16 executes address resolution and network resolution (path calculation) while referring to the information stored in the external WAN server 14 as described later. Execution of address resolution and network resolution (path calculation) enables communication from the terminal device 13a to the terminal device 13e via the segments.

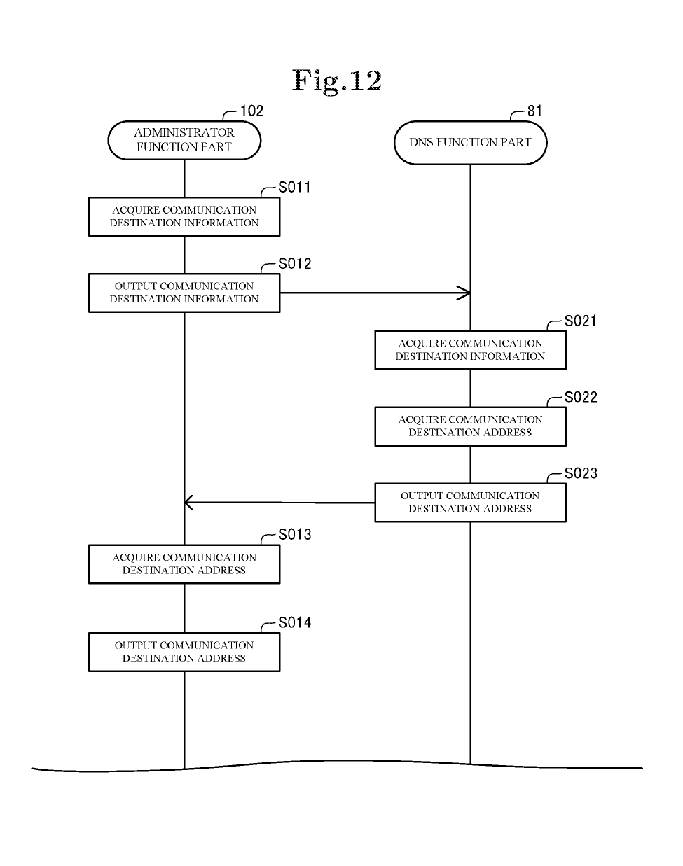

First, referring to FIG. 12, address resolution will be described. Upon acquiring the internal transfer setting information including the communication destination information (step S011), the administrator function part 102 of the higher-level information processing unit 16 outputs the communication destination information included in the internal transfer setting information to the DNS function part 81 within the external WAN server 14 (step S012). Upon receiving the communication destination information (step S021), the DNS function part 81 acquires a communication destination address (e.g., an IP address) stored in the DNS function part 81 in association with the received communication destination information (step S022). Then, the DNS function part 81 outputs the acquired communication destination address to the administrator function part 102 (step S023). After that, upon acquiring the communication destination address from the DNS function part 81 within the external WAN server 14 (step S013), the administrator function part 102 outputs the communication destination address to the terminal device 13 via the information processing unit 11A within the segment 1 (step S014). Through the operation described above, the terminal device 13 can acquire a communication destination address, which is address information of a communication destination device.

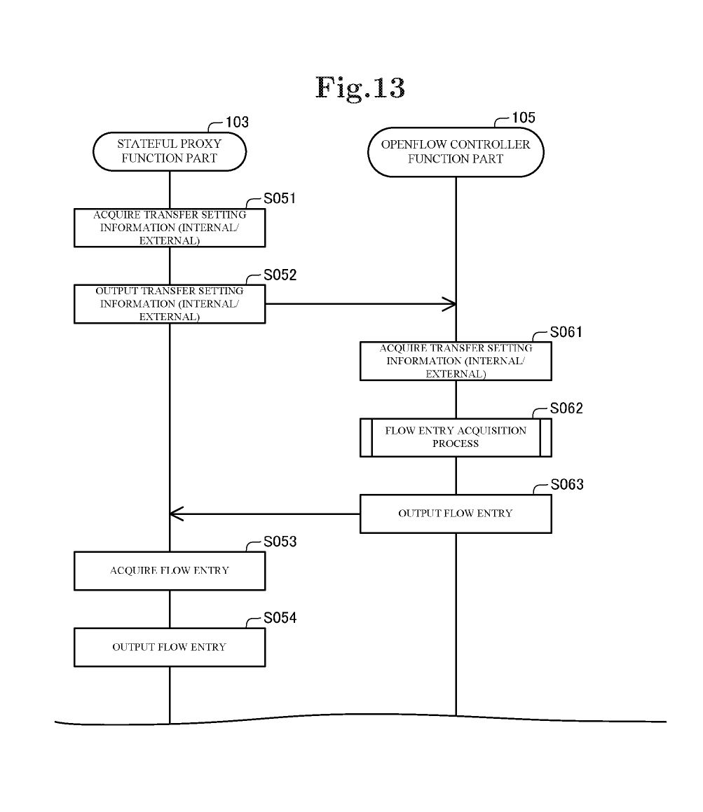

Next, referring to FIG. 13, network resolution will be described. Network resolution may be executed in parallel with the address resolution shown in FIG. 12.

In this exemplary embodiment, communication passing through the segments 1 and 2 is performed as stated above. Therefore, the administrator function part 102 of the higher-level information processing unit 16 sends a signal to the external WAN server 14 so that the external WAN server 14 transmits external transfer setting information such as topology information of the segment 2 stored therein. Upon receiving the signal, the external WAN server 14 transmits external transfer setting information composed of topology information, flow table information and policy information of the inside of the segment 2, which are respectively recorded on the topology information DB 82, the flow table information DB 83 and the policy information DB 84 included by the external WAN server 14, to the administrator function part 102 included by the higher-level information processing unit. Through the operation described above, the administrator function part 102 included by the higher-level information processing unit acquires transfer setting information (internal/external) including: the internal transfer setting information composed of the topology information, flow table information and policy information of the inside of the segment 1; and the external transfer setting information including the topology information, flow table information and policy information of the inside of the segment 2. The succeeding operation will be described with FIG. 13.

As stated above, the administrator function part 102 acquires the transfer setting information (internal/external). Then, the administrator function part 102 outputs the transfer setting information (internal/external) to the OpenFlow controller function part 105 via the stateful proxy function part 103 (steps S051 and S052). Next, upon acquiring the transfer setting information (internal/external) from the stateful proxy function part 103 through the operation described above (step S061), the OpenFlow controller function part 105 executes a flow entry acquisition process for acquiring a flow entry to be described later, by using the transfer setting information (internal/external) (step S062). Then, the OpenFlow controller function part 105 outputs the flow entry acquired through the operation described above to the stateful proxy function part 103 (step S063). After that, upon acquiring the flow entry, the stateful proxy function part 103 outputs the flow entry to the respective OpenFlow switches via the administrator function part 102 (step S054). Through the operation described above, the administrator function part 102 executes network resolution.

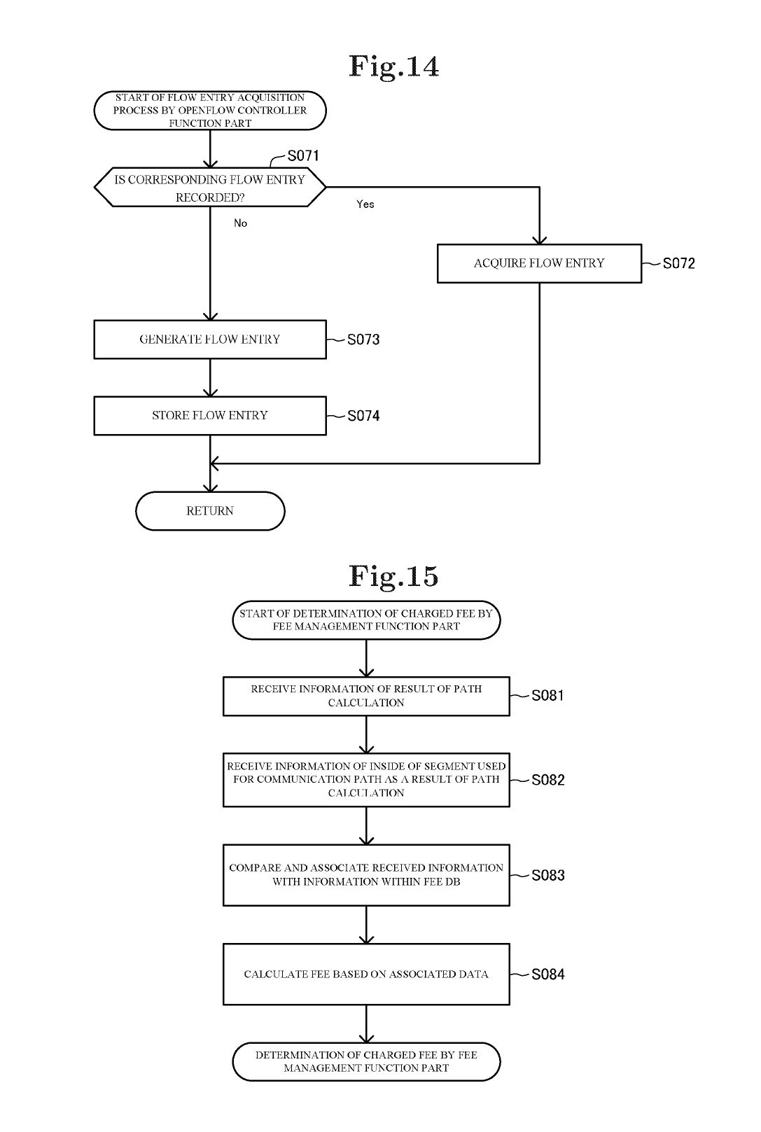

Next, referring to FIG. 14, the flow entry acquisition process will be described.

As shown in FIG. 14, the OpenFlow controller function part 105 first determines whether or not an associated flow entry is recorded (step S071). That is to say, the OpenFlow controller function part 105 determines whether or not information based on at least one of the communication source information and the communication destination information within the transfer setting information (internal/external) acquired in processing at step S061 of FIG. 13 is included in “conditions” of flow entries recorded in the acquired flow table information of the segments 1 and 2.

In the case of determining that an associated flow entry is stored (step S071: Yes), the OpenFlow controller function part 105 acquires the flow entry stored in the flow table information (step S072), and outputs the flow entry to the stateful proxy function part 103.

On the other hand, in the case of determining that an associated flow entry is not stored (step S071: No), the OpenFlow controller function part 105 generates a flow entry on the basis of the topology information, flow table information and policy information of the inside of the segment 1 and the topology information, flow table information and policy information of the inside of the segment 2, which are included by the transfer setting information (internal/external) (step S073). Moreover, in the generation, the OpenFlow controller function part 105 refers to the communication service information stored in the communication service DB as necessary to generate a flow entry. That is to say, the OpenFlow controller function part 105 sets a path between the communication source device and the communication destination device on the basis of the transfer setting information (internal/external) (and the communication service information), and sets the “condition” for transferring packet information through the set path and the “content of processing.”

Then, the OpenFlow controller function part 105 stores the generated flow entry and also outputs the flow entry to the stateful proxy function part 103 (step S074).

Upon acquiring the flow entry generated by the OpenFlow controller function part 105 in the abovementioned method, the stateful proxy function part 103 outputs the flow entry to the OpenFlow switches 31 via the virtual machine control function part 41 (see step S054 in FIG. 13).

As stated above, the higher-level information processing unit 16 refers to the information stored in the external WAN server 14, and the higher-level information processing unit 16 can thereby execute network resolution for the OpenFlow switches in the networks of the respective segments (see FIG. 14). That is to say, setting a path leading from the terminal device 13a to the terminal device 13e and setting the “condition” for transferring packet information through the set path and the “content of processing” allows communication by the terminal device 13a and the terminal device 13e shown in FIG. 13.

The succeeding flow is as stated for the configuration of the OpenFlow switch 31. That is to say, upon receiving the flow entry, each of the OpenFlow switches 31 sets the flow entry in the flow table (transfer setting). Then, when transfer setting is complete, the OpenFlow switches 31 each transmit a setting completion notice to the external WAN server 14 via the administrator function part 42 within the information processing unit 11A. After that, upon receiving setting completion notices from all the OpenFlow switches 31 that are the target of setting, the external WAN server 14 makes a communication start instruction to a terminal which is to perform communication and the OpenFlow switch 31 to be used in communication, via the administrator function part 42 within the information processing unit 11A. This activity allows the OpenFlow switch 31 to be used in communication to properly process packets transmitted in the communication.

By the method described above, it is possible to execute path calculation with respect to a network of a different segment.

Then, after path calculation by the higher-level information processing unit 16 described above, a charging process by the fee management function part 108 is executed. To be specific, the fee management function part 108 first receives the result of path calculation from the OpenFlow controller function part 105 (step S081). Moreover, the fee management function part 108 receives network information of the inside of segments to be used for a communication path as a result of the path calculation (step S082) (in this exemplary embodiment, receives topology information, policy information and flow table information of the segments 1 and 2; communication service information may be received as necessary). Then, the fee calculation part 102 associates the received information with information recorded in the fee DB 113 (e.g., how much is charged for every segment passed through) (calculates a charged fee by using the received information and the information in the fee DB 113) (step S983). In this exemplary embodiment, because the number of segments passed through is two, the fee calculation part 112 determines a fee by using the information stored in the fee DB 113 corresponding to the number of segments passed through=2). Through the operation described above, a charged fee is determined (step S084).

Such a configuration enables a telecommunications carrier having the external WAN server 14 to manage a communication path passing through segments by using the facility of a provider that is different from the telecommunications carrier. Therefore, the telecommunications carrier does not need to fix its own facility for managing a communication path. As a result, it is possible to solve the problem that a telecommunications carrier needs to manage facilities invested thereby on its own and hence investment in communication facilities gets large. Further, in this exemplary embodiment, the telecommunications carrier manages the external WAN server 14. However, the practice of the present invention is not limited to such a case. Management of the external WAN server 14 may be outsourced. In this case, a higher effect can be expected in reduction of investment in communication facilities.

Further, this exemplary embodiment has shown the case of contacting the higher-level information processing unit 16 via the information processing unit 11A. However, the present invention can be practiced with no problem even if not via the information processing unit 11A. To be specific, the higher-level information processing unit 16 may directly receive internal transfer setting information from the OpenFlow switch 31 of the network 12a. Furthermore, this exemplary embodiment has shown the case where the higher-level information processing unit 16 is different from the information processing unit 11A (and the information processing unit 11B). However, the information processing unit 11A (11B) may concurrently serve as the higher-level information processing unit 16. In this case, the charging unit is included by the information processing unit 11A (11B) or included by an external device as mentioned above.

### Second Exemplary Embodiment

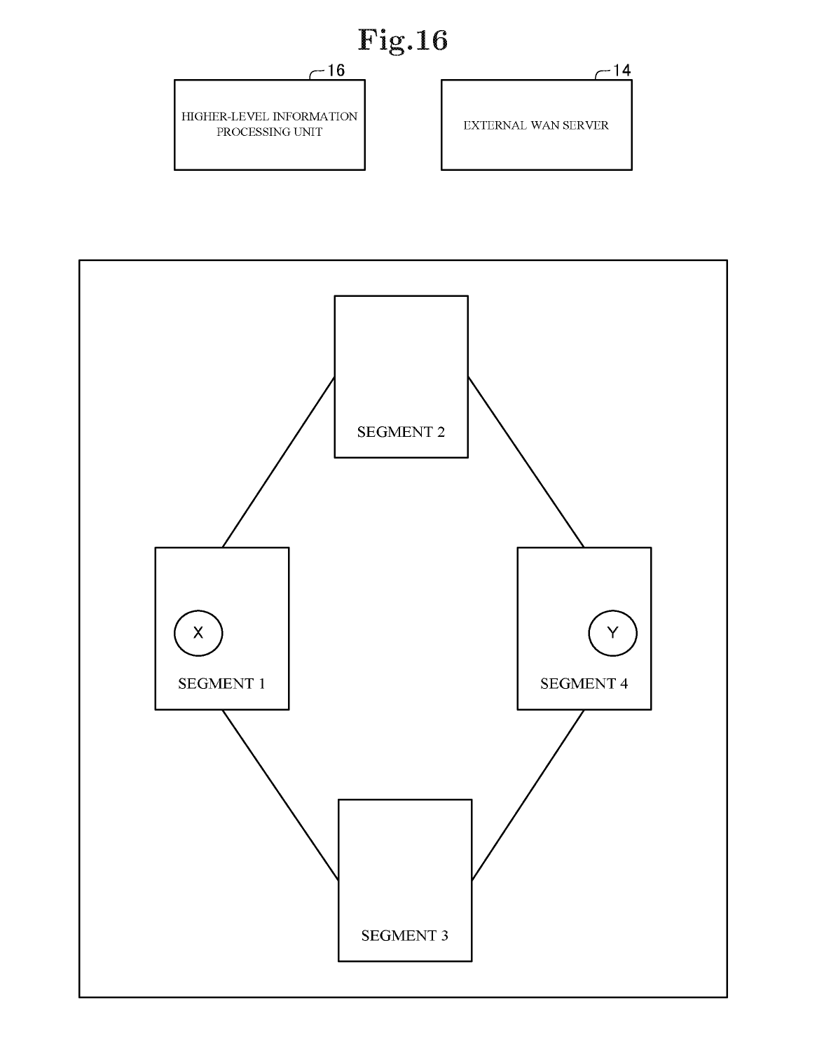

Next, a communication system according to a second exemplary embodiment of the present invention will be described referring to FIG. 16. The second exemplary embodiment includes the same configuration as the first exemplary embodiment. That is to say, a plurality of segments, the external WAN server 14 and the higher-level information processing unit 16 are provided. Moreover, the structure of the inside of the segment is the same as that shown in the first exemplary embodiment. In this exemplary embodiment, there are four segments as shown in FIG. 16. Meanwhile, this exemplary embodiment can be practiced independent of the number of the segments as the first exemplary embodiment.

The second exemplary embodiment shows that determination of a fee by the fee management function part 108 is not limited to the case shown in the first exemplary embodiment. The first exemplary embodiment has illustrated the case where the fee management function part 108 determines a fee depending on the number of segments through which a communication path established by the higher-level information processing unit 16 passes. However, the present invention can be practiced beyond such a case. For example, the fee management function part 108 can determine a fee on the basis of various characteristics of segments through which a communication path passes other than the number of the segments. Thus, in the second exemplary embodiment, a configuration that the fee management function part 108 determines a fee on the basis of the characteristics of segments passed through other than the number of the segments will be described.

In the second exemplary embodiment, as stated above, the fee management function part 108 determines a fee on the basis of the characteristics of segments through which a communication path established by the higher-level information processing unit 16 passes. Therefore, the administrator function parts 42 within the respective segments acquire various kinds of information in addition to that shown in the first exemplary embodiment, and transmit them to the external WAN server 14.

To be specific, the characteristics of segments are “throughput: 500 Mbps,” “the number of nodes (e.g., a delay because there are many),” “a failure rate,” “the number of flow entries stored in a flow table,” and so on. On the basis of such characteristics of segments, the fee management function part 108 determines a fee. Therefore, in this exemplary embodiment, the administrator function parts 42 within the respective segments acquire various kinds of characteristics of segments as mentioned above and transmit them to the external WAN server 14. In this exemplary embodiment, every time there is a change in a network, the administrator function part 42 controlling the network can acquire information about the change. Therefore, in this exemplary embodiment, it is possible to not only determine a fee on the basis of the theoretical value of throughput, but also determine a fee on the basis of the characteristics of the respective segments when the higher-level information processing unit 16 establishes a communication path in consideration of the distribution amount of information, the congestion state to be described later, and so on.

To be specific, in the case shown by FIG. 16, let us suppose the throughput of the segment 2 is 500 Mbps (theoretical value) and the throughput of the segment 3 is 50 Mbps (theoretical value). Then, in a case where the higher-level information processing unit 16 establishes a communication path leading from the segment 1 to the segment 4 via the segment 2, segments capable of realizing a higher communication speed are used as compared with a case of establishing a communication path passing through the segments 1, 3 and 4. Therefore, in a case where a communication path using the segment 2 is established, the fee management function part 108 determines a higher fee than in a case where a communication path using the segment 3 is established. To be specific, for example, the fee DB 113 which the fee management function part 108 uses when determining a fee is configured to be capable of storing various conditions such as “how much an additional fee is in using the segment of 500 Mbps” and “no additional fee in the case of a predetermined communication speed or less (e.g., 100 Mbps or less).” With the configuration of the fee DB 113, for example, in a case where the higher-level information processing unit 16 establishes a communication path passing through the segment 2, the fee management function part 108 can determine a fee by using information that “the throughput of the segment 2 is 500 Mbps” stored in the external WAN server 14 and information that “how much an additional fee is in using the segment of 500 Mbps” stored in the fee DB. Moreover, in a case where the higher-level information processing unit 16 establishes a communication path passing through the segment 3, the fee management function part 108 can determine to charge no additional fee.

Further, the fee management function part 108 can determine a fee depending on other characteristics of segments at the time of establishment of a communication path. For example, let us suppose a delay is occurring due to congestion or the like though the throughput of the segment 2 is 500 Mbps. The fee management function part 108 may be configured to, in such a case, determine a fee in consideration of the information. By thus configuring the fee management function part 108, the fee management function part 108 can determine to, for example, charge no additional fee because a delay is occurring in the segment 2 though the segment 2 is used as a communication path.

Other than the case shown in this exemplary embodiment, it is possible to store various kinds of information such as “add a fee when using a segment with a failure rate of 0” and “discount a fee when using a segment including many nodes” into the fee DB. Thus storing various kinds of information into the fee DB enables the fee management function part 108 to determine a fee depending on various characteristics of segments.

According to the present invention, it is possible to determine a fee in accordance with not only the number of segments but also various characteristics of the segments. Therefore, it is possible to determine a fee more depending on an established communication path. This exemplary embodiment has shown that it is possible to determine a fee in accordance with not only the number of segments passed through but also the characteristics of the segments. However, the present invention is not limited to the case. For example, it is possible to determine a fee depending on a communication path. To be specific, the fee management function part 108 may be configured to be capable of determining a fee depending on the characteristic of segments passed through, for example, determining a fee depending on the distance between the segments passed through.

### Third Exemplary Embodiment

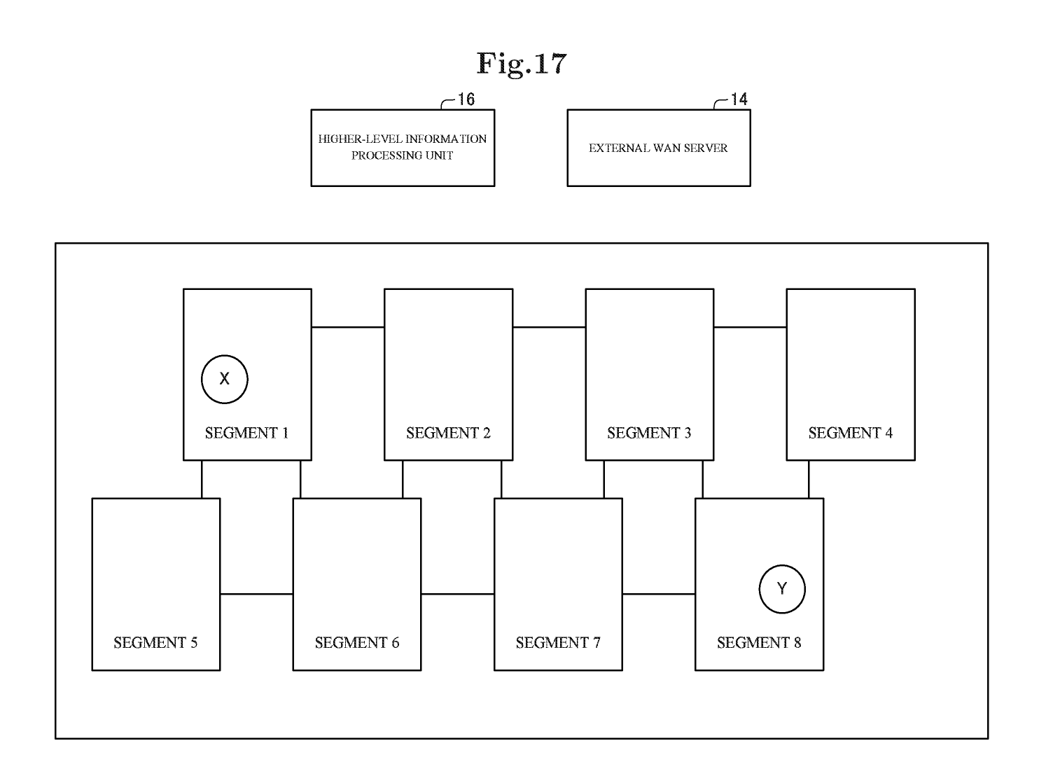

Next, a communication system according to a third exemplary embodiment of the present invention will be described referring to FIGS. 17 to 21. The communication system according to the third exemplary embodiment is a communication system in which the number of the segments described in the first and second exemplary embodiments is plural (there are many segments). That is to say, the third exemplary embodiment describes a case where it is required to establish a communication path passing through a plurality of segments.

### (Configuration)

The structure of the inside of a single segment is the same as the structure described in the first and second exemplary embodiments. In other words, a single segment is configured by the information processing unit 11, the network 12 configured by connecting the OpenFlow switches 31, and the terminal devices 13 connecting to the network. Moreover, the network within each segment is connected to at least one of the networks within the other segments.

For example, as shown in FIG. 17, the network 12 within the segment 1 is connected to the networks 12 within the segments 2, 5 and 6 by an internetworking device 15. Moreover, the network 12 within the segment 2 is connected to the networks 12 within the segments 3, 6 and 7 in addition to the network 12 within the segment 1, and the network 12 within the segment 3 is connected to the networks within the segments 4, 7 and 8 in addition to the network within the segment 2. Likewise, the network 12 within the segment 4 is connected to the network within the segment 8 in addition to the network 12 within the segment 3, and the network 12 within the segment 5 is connected to the network 12 within the segment 6 in addition to the network 12 within the segment 1. Moreover, the network 12 within the segment 6 is connected to the network 12 within the segment 7 in addition to the networks 12 within the segments 1, 2 and 5, and the network 12 within the segment 7 is connected to the network 12 within the segment 8 in addition to the networks 12 within the segment 2, 3 and 6. Although this exemplary embodiment shows a case where the respective networks are connected in the abovementioned manner, the present invention can be practiced independent of the number of connections of the networks within a plurality of segments and there is no problem as far as a plurality of segments are passed through.

Further, as in the first and second exemplary embodiments, the external WAN server 14 aggregates information collected by the administrator function parts 42 of the information processing units 11 within the respective segments. That is to say, the external WAN server 14 aggregates the topology information, flow table information, policy information and so on of the networks within the segments 1, 2, 3, 4, 5, 6, 7 and 8.

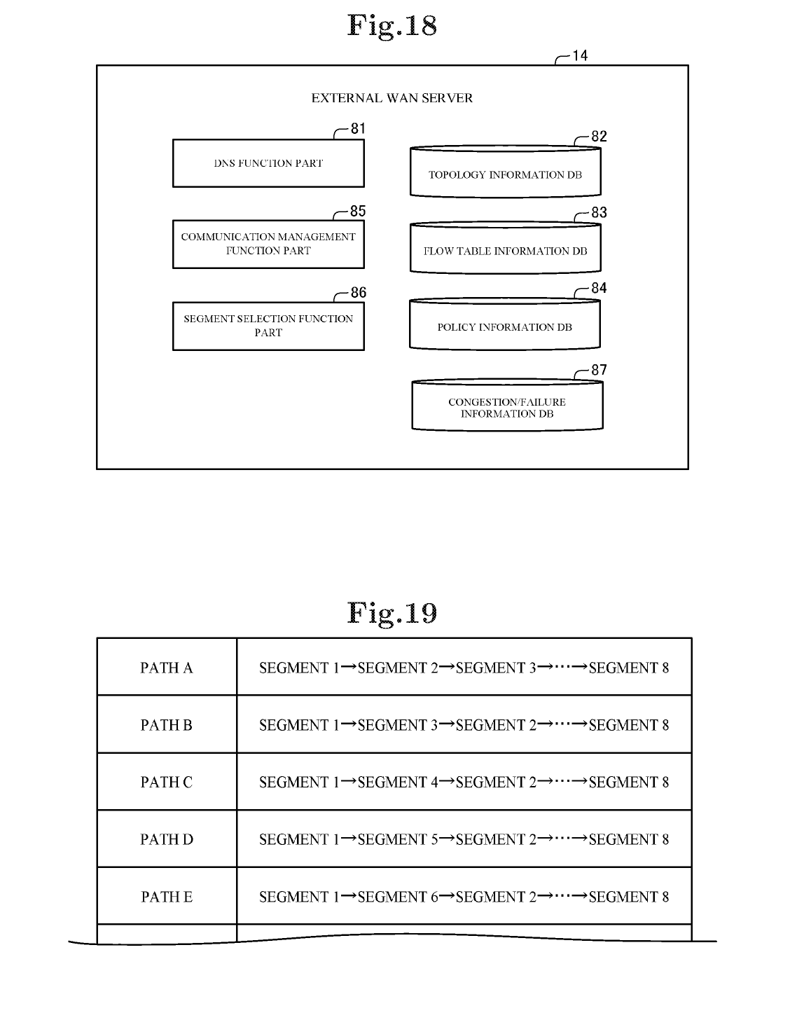

The external WAN server 14 in the third exemplary embodiment has not only the function of aggregating information of the respective segments but also a function of using the aggregated information of the respective segments and determining segments (a segment sequence) to be subjected to address resolution and network resolution. Thus, as shown in FIG. 18, the external WAN server 14 in the third exemplary embodiment includes, in addition to the components shown in the first exemplary embodiment (see FIG. 7), a segment selection function part 86 (a segment selection unit) which selects segments (networks within segments) to be used for path calculation (address resolution, network resolution). Besides, the external WAN server 14 in this exemplary embodiment may include a congestion/failure information DB 87.

First, the segment selection function part 86 will be described. The segment selection function part 86 is a part which selects a segment sequence to be subjected to path calculation, by using information of the respective segments aggregated by the external WAN server 14. To be specific, as shown in FIG. 19, the segment selection function part 86 of the external WAN server 14 lists all the combinations of the segments 1 to 8 and then eliminates duplicated ones. Next, by using the topology information gathered by the administrator function parts 42 of the respective segments described above, the segment selection function part 86 deletes a path including segments arranged without a contiguous point between the networks. For example, a path B shown in FIG. 19 includes a sequence “segment 1→segment 3” in which the networks within the respective segments are not connected. Likewise, a path C includes a sequence “segment 1→segment 4” in which the networks are not connected, and a path D includes a sequence “segment 5→segment 2” in which the networks are not connected (see FIG. 17). The segment selection function part 86 deletes such paths including a sequence without a contiguous point by using the topology information recorded in the external WAN server 14. Then, the segment selection function part 86 selects networks to be subjected to path calculation in a manner that the number of the connection points of the networks is smaller. In this exemplary embodiment, segments to be subjected to path calculation are selected in a manner that the number of the connection points of the networks is smaller, but selection of the segments is not limited to the abovementioned method. For example, use of flow table information in addition to topology information enables estimation of the distribution amount of information within a segment relating to the flow table information from the number of flow entries in the flow table information. On the basis of information of the estimated distribution amount, segments may be selected in a manner that the amount of distributed information becomes smaller (assumed to be far from the congestion state).

Here, it can be conceived that the segment selection function part 86 narrows segment sequences to be used for path calculation to one. On the other hand, in a case where a plurality of segment sequences have an identical number of connection points, the segment selection function part 86 may narrow them to plural, for example, about ten, and then select networks to be subjected to path calculation. The segment selection function part 86 may realize its function as one function within the external WAN server 14 as shown in this exemplary embodiment, or may realize its function with an additionally provided device which is independent of the external WAN server 14, for example.

Next, the congestion/failure information DB 87 will be described. The congestion/failure information DB 87 is a DB which stores information whether the network within each segment is in the congestion/failure state. The administrator function parts 42 within the respective segments collect congestion/failure information of the networks within the respective segments and aggregate the information into the external WAN server 14. Then, the congestion/failure information aggregated into the external WAN server 14 is stored into the congestion/failure information DB 87. The segment selection function part 86 within the external WAN server 14 described above can select a segment sequence to be used for path calculation by using the congestion/failure information aggregated into the congestion/failure DB 87. That is to say, the segment selection function part 86 can determine a network (a segment including a network) in the congestion/failure state from the congestion/failure information stored in the congestion/failure DB 87, and select a segment sequence while avoiding the network in the congestion/failure state.

Further, selection of a segment sequence by the segment selection function part 86 may be performed by using the communication service DB. To be specific, when the administrator function parts 42 within the respective segments gather topology information and so on into the external WAN server 14, the higher-level information processing unit 16 transmits communication service information stored in the communication service DB to the external WAN server 14 via the administrator function part 102 (or the higher-level information processing unit 16 having received an instruction from the external WAN server 14 transmits communication service information stored in the communication service DB to the external WAN server 14). Accordingly, communication service information is also aggregated by the external WAN server 14. Therefore, the segment selection function part 86 selects a segment sequence by using the communication service information. Thus, the segment selection function part 86 can be configured to determine a segment sequence used for path calculation so as to realize a communication service contained in the communication service information.

For example, let us suppose that communication service information of a guarantee of a given quality of image/sound is stored in the communication service DB. In this case, in selecting a segment sequence, the segment selection function part 86 selects a segment sequence which satisfies an allowable range for realization of the given quality of image/sound. The segment selection function part 86 can thus select a segment sequence which meets communication service information stored in the communication service DB.

The operation after a segment sequence to be used for path calculation is selected by the segment selection function part 86 as described above is the same as in the first and second exemplary embodiments. That is to say, the higher-level information processing unit 16 calculates a communication path passing through the segments selected by the segment selection function part 86 by using the information aggregated by the external WAN server 14. To be specific, for example, to perform communication from X within the segment 1 to Y within the segment 8 as shown in FIG. 18, the higher-level information processing unit 16 executes communication path calculation on one segment sequence or a plurality of (e.g., ten) segment sequences selected by the segment selection function part 86.

Further, the information processing units 11 in the respective segments and the higher-level information processing unit 16 each include a communication path determination unit, which is not shown in the drawings. As stated above, the higher-level information processing unit 16 executes communication path calculation on one segment sequence or a plurality of (e.g., ten) segment sequences selected by the segment selection function unit 86. Therefore, in a case where a plurality of segment sequences are selected by the segment selection function part 86, path calculation is executed plural times. Then, the higher-level information processing unit 16 having executed path calculation on a plurality of segment sequences as mentioned above needs to determine a segment sequence actually used in communication from among the segment sequences having been subjected to the path calculation. A means used in the determination is the communication path determination unit. For example, in a case where the segment selection function part 86 narrows segment sequences to be subjected to path calculation to ten, the higher-level information processing unit 16 executes path calculation on the ten segment sequences. In this case, ten path calculation results are obtained. Therefore, the higher-level information processing unit 16 needs to determine one communication path to be actually used in communication from among the ten segment sequences having been subjected to the path calculation. Thus, one path to be actually used in communication is determined by using the communication path determination unit.

The communication path determination unit determines a communication path to be used in communication by, for example, comparing flow tables. To be specific, for example, when the segment selection function unit 86 narrows network sequences to ten, the higher-level information processing unit 16 executes path calculation on the ten network sequences. Then, the communication path determination unit compares the results of the path calculation and determines, as a communication path to be used in communication, a path passing through switches having less flow tables, namely, a path connected by switches whose communication traffic is supposed to be the least. Although a communication path is thus determined in this exemplary embodiment, determination of a communication path according to the present invention is not limited to use of the abovementioned means as far as it is possible to determine a communication path by using any means.

Then, after a communication path is determined, the charging process by the fee managing function part 108 is executed as stated above. Regarding the charging process in this exemplary embodiment, it is possible to change a charged fee in accordance with selection of segments by the segment selection function part 86. Therefore, information which is necessary for calculation of the fee is stored in the fee DB 113 of the fee management function part 108 in this exemplary embodiment.

To be specific, at the time of collection of information which is necessary for determining the amount of money to be charged, the fee management function part 108 collects information on selection of segments and information having been used in selection of the segments from the segment selection function part 86.

For example, let us suppose a case where the segment selection function part 86 has selected a segment sequence while avoiding a segment including a network in the congestion/failure state by referring to the congestion/failure information stored in the congestion/failure information DB 87. In this case, the fee management function part 108 can determine a charged fee in consideration of a fact that the segment sequence has been selected on the basis of the congestion/failure information. That is to say, the fee management function part 108 can calculate a charged fee on the basis of a “fee used in selecting a segment sequence on the basis of the congestion/failure information” which is stored in the fee DB 113. Moreover, in a case where a segment sequence has been selected by using communication service information stored in the communication service DB, the fee management function part 108 can determine a fee in consideration of a fact that the segment sequence has been selected in accordance with the communication service information.

In this exemplary embodiment, the information processing units 11 within the respective segments and the higher-level information processing unit 16 each include the communication path determination unit. With this configuration, regardless of which information processing unit 11 executes path calculation, the information processing unit executing the path calculation includes the communication path determination unit. Therefore, it is possible to determine a communication path by using the communication path determination unit within the information processing unit executing the path calculation. However, all the information processing units within the respective segments do not need to include the communication path determination units. For example, the external WAN server 14 may have the communication path determination unit. In this case, after execution of path calculation on a plurality of segment sequences, determination of a communication path is asked to the external WAN server again. Alternatively, an external device which is independent of the external WAN server may have the function.

Further, this exemplary embodiment describes that communication service information and congestion/failure information are different. However, the present invention is not limited to such a case. That is to say, congestion/failure information and communication service information may be integrally configured. For example, in a case where communication service information includes information that “avoid a segment in the congestion/failure state,” the segment selection function part 86 can select a segment sequence while “avoiding a segment in the congestion/failure state” by using the communication service information.

Next, the operation of the communication system in the third exemplary embodiment will be described. The operation shown in this exemplary embodiment is an operation in a case where communication via a plurality of segments from X within the segment 1 to Y within the segment 8 shown in FIG. 17 is performed.

### (Operation)

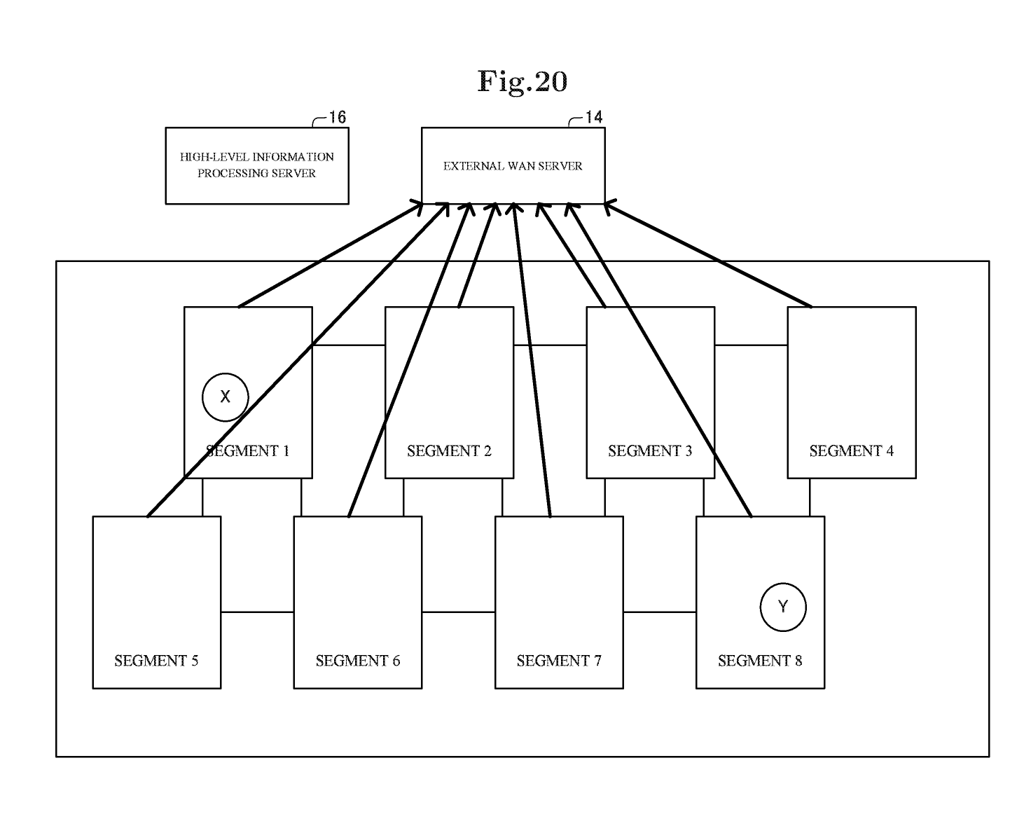

First, in the operation of the communication system according to the third exemplary embodiment, when there is a need to calculate a communication path passing through a plurality of segments, the topology information, flow table information and policy information of segments which are potentially used for the communication path are aggregated by the external WAN server 14 from the administrator function parts 42 within the respective segments (or the respective information are aggregated by the external WAN server 14 in advance) as shown by arrows in FIG. 20.

Next, the external WAN server 14 (the segment selection function part 86 therein) lists sequences of the segments whose information has been aggregated as shown in FIG. 19. A sequence including segments arranged without a contiguous point is eliminated from among the listed segment sequences by using the topology information aggregated by the external WAN server 14. Then, the external WAN server 14 selects a path in which the number of connection points is smaller from among sequences of segments contiguous with each other. The path may be selected by narrowing to one if segments passed through are not so many as shown in FIG. 17, for example. On the other hand, it is also possible to use a method such as narrowing segments used for path calculation to some degree, for example, selecting about ten paths with less connection points.

Let us suppose, in the case shown in FIG. 17, the external WAN server 14 (the segment selection function part 86 therein) selects a sequence of the segments 1, 2, 7, 8 and a sequence of segments 1, 2, 3, 8 from among a plurality of segment sequences. The sequence of the segments 1, 2, 7, 8 and the sequence of the segments 1, 2, 3, 8 are sequences of segments having mutual connection points and less connection points. Then, the external WAN server 14 gives an instruction to calculate a communication path passing through the segments 1, 2, 7, 8 and a communication path passing through the segments 1, 2, 3, 8 to the higher-level information processing unit 16. Upon receiving the instruction, the higher-level information processing unit 16 executes path calculation on the respective sequences by using the information stored in the external WAN server 14 storing the information of the networks within the segments 1, 2, 3, 7 and 8 as shown in the first exemplary embodiment.

The selection of a segment sequence by the segment selection function part 86 described above may be performed by using congestion/failure information stored in the congestion/failure DB 87 and communication service information stored in the communication service DB as stated before.

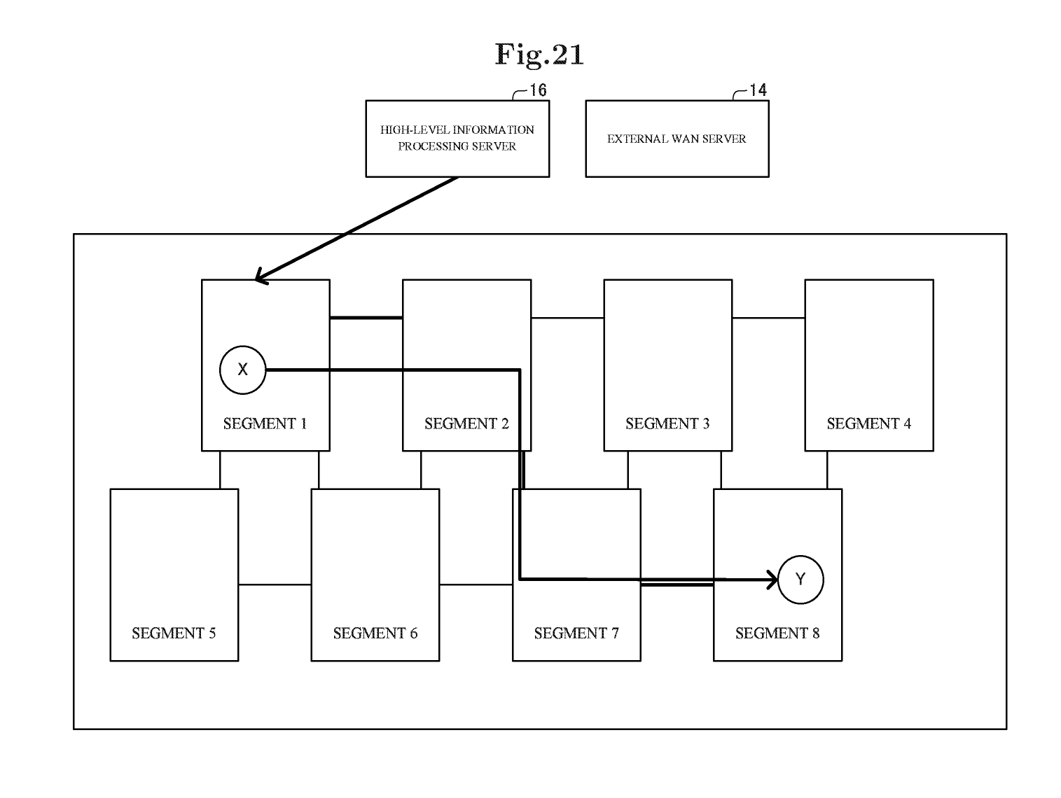

Next, the communication path determination unit within the higher-level information processing unit 16 having executed the path calculation determines a communication path to be actually used in communication. Let us suppose, in the case shown in FIG. 20, a path passing through switches with less flow tables, namely, a path connected by switches whose communication traffic is supposed to be the least is the sequence of the segments 1, 2, 7, 8, for example. Then, as shown in FIG. 21, the communication path determination unit within the higher-level information processing unit 16 determines to use the sequence of the segments 1, 2, 7, 8 as a communication path, and transmits a corresponding flow entry to the OpenFlow switches within the networks within the segments 1, 2, 7 and 8. Through the operation described above, network resolution is executed, and communication from X within the segment 1 to Y within the segment 8 is allowed.

After that, the fee management function part 108 determines a charged fee in consideration of selection of the segment sequence by the segment selection function part 86. The description of the charging process will be omitted because it has been made before.

The operation described above makes it possible to execute path calculation even if calculation of a communication path passing through a plurality of segments is necessary. Therefore, a telecommunications carrier having an external WAN server can fully outsource management of a communication facility such as management of path calculation to a provider which is different from the telecommunications carrier. As a result, the telecommunications carrier does not need to manage the facility invested thereby on its own. That is to say, it is possible to solve the problem that facility investment becomes large because a telecommunications carrier needs to manage a facility invested thereby.

### Fourth Exemplary Embodiment

Next, a communication system according to a fourth exemplary embodiment of the present invention will be described. The communication system according to the fourth exemplary embodiment has the same configuration as in the case where there are a plurality of segments as described in the third exemplary embodiment.

The fourth exemplary embodiment shows a case where there are a plurality of ranges each of which is a range where the external WAN server 14 aggregating information from a plurality of segments aggregates information. Let us suppose, in this exemplary embodiment, the external WAN server 14 is provided for every telecommunications carrier. Therefore, the fourth exemplary embodiment is an exemplary embodiment showing a case where there is a need to perform communication via a plurality of carriers. The fourth exemplary embodiment includes, in addition to the components included by the third exemplary embodiment, a higher-level information aggregation server which aggregates information aggregated by the respective external WAN servers 14 (the higher-level information aggregation server is equivalent to an information aggregation unit).

The higher-level information aggregation server aggregates and stores topology information, flow table information, policy information and congestion/failure information aggregated by the respective external WAN servers 14. For that purpose, the higher-level information aggregation server has a database for recording the respective information. Moreover, the higher-level information aggregation server has a DNS function part and a segment selection function part.

By using the information described above, the higher-level information aggregation server selects a group to be used for a communication path from among groups from which the respective external WAN servers aggregate the information. A means used in the selection is the same as that shown in the second exemplary embodiment. That is to say, it is determined by using topology information whether sections are contiguous with each other, and a group in the congestion/failure state is omitted by using congestion/failure information. In the fourth exemplary embodiment, it is also possible to set so as not to delete a path from which congestion/failure information is obtained, in a case where the group has only some congestion/failure and it is possible to bypass the congestion/failure in the group and perform communication.

The operation after selection of the group through the abovementioned operation is the same as the operation described in the second exemplary embodiment. By using the higher-level information aggregation server described above, it is possible to establish a communication path without any problem even if, for example, there is a need to establish a communication path passing through a plurality of telecommunications carriers.

Further, this exemplary embodiment shows a case where a plurality of external WAN servers 14 exist. Therefore, an additional configuration is necessary for transmitting a flow entry to each OpenFlow switch and receiving a setting completion notice from the OpenFlow switch to start communication.

To be specific, carrier network IDs (external WAN IDs) are previously assigned to the respective external WAN servers 14 used in this exemplary embodiment. The carrier network IDs do not overlap each other. Further, a communication management function part of each of the external WAN servers includes an ID information storage part which temporarily stores ID information, and an ID comparison part which compares the information stored in the ID information storage part with a setting completion ID showing completion of path setting in all the OpenFlow switches controlled thereby.

The operation from notice of setting completion to start of communication in this exemplary embodiment will be described. First, let us suppose that establishment of a path is required with start of communication and path calculation is then executed. The operation in this process is as described before. Then, at a stage where a communication path to be used for communication is determined as a result of path calculation (at a stage where a flow entry is transmitted to the OpenFlow switches in the respective segments), each of the external WAN servers 14 corresponding to segments to be used for the communication path transmits a carrier network ID assigned to the external WAN server 14 to a communication starting external WAN server which has started the communication. Upon receiving carrier network IDs from the respective WAN servers, the communication starting external WAN server 14 stores the carrier network IDs of the respective external WAN servers 14 to be used for the communication path into the ID information storage part within the communication starting external WAN server 14. Next, each of the external WAN servers 14 having received setting completion notices from all the OpenFlow switches controlled thereby transmits the carrier network ID of the external WAN server 14 as a setting completion ID to the communication starting external WAN server 14. Upon receiving the setting completion ID, the communication starting external WAN server 14 causes the ID comparison part to perform comparison of the setting completion ID with the carrier network IDs stored in the ID information storage part. In the case of determining that path setting is complete in all the external WAN servers 14 as a result of the comparison, the communication starting external WAN server 14 instructs start of communication as described above. On the other hand, in a case where the IDs stored in the storage part do not meet the setting completion IDs after a given time passes, the communication starting external WAN server 14 instructs the information processing unit to execute network resolution again.

Through the operation described above, in a case where a plurality of external WAN servers 14 exist, a communication starting external WAN server 14 can instruct start of communication after completion of setting in the respective OpenFlow switches.

Further, in this exemplary embodiment, the fee management function part 108 can also determine a fee depending on the number of telecommunications carriers passed through. That is to say, information on charged fees which increase in accordance with the number of telecommunications carriers passed through is previously stored into the fee DB 113 and, by using the information stored in the fee DB 113, the fee management function part 108 can determine a fee depending on the number of telecommunications carriers which a communication path passes through.

### Fifth Exemplary Embodiment

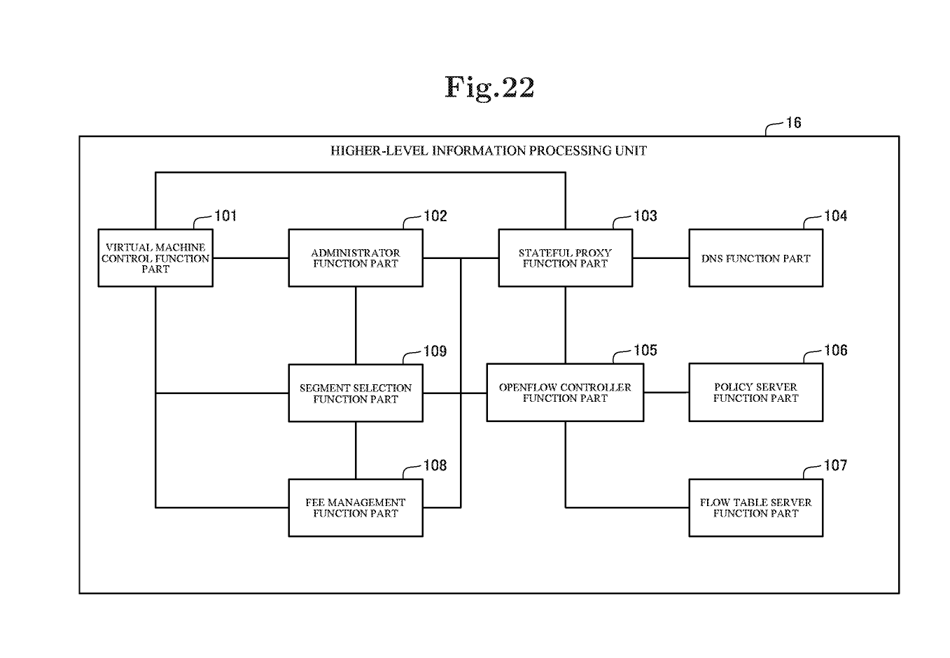

Next, a communication system according to a fifth exemplary embodiment of the present invention will be described with FIG. 22. The communication system according to the fifth exemplary embodiment is another aspect of the communication systems described in the second to fourth exemplary embodiment.

In the second to fourth exemplary embodiments, the external WAN server 14 includes the segment selection function part 86 as shown in FIG. 18, for example. However, as stated before, it can also be conceived not to use the external WAN server 14 (an external server) as the information aggregation unit. In this exemplary embodiment, a case where the external WAN server 14 is not used as the information aggregation unit will be described. In a case where the external WAN server 14 is not used as the information aggregation unit, the administrator function parts of the information processing units 11 or of the higher-level information processing unit 16 are configured to serve as the information aggregation unit.

As shown in FIG. 22, the higher-level information processing unit 16 in this exemplary embodiment includes the same components as shown in the first to fourth exemplary embodiments. Then, in this exemplary embodiment, the higher-level information processing unit 16 further includes a segment selection function part 109.

As stated above, in a case where the external WAN server 14 is not used as the information aggregation unit, the administrator function part 102 included by the higher-level information processing unit 16 serves as the information aggregation unit. That is to say, the administrator function part 102, as necessary, acquires network information of another segment from the information processing unit 11 belonging to the other segment via the administrator function part 102 belonging to the other segment. Such a configuration makes the higher-level information processing unit 16 serve as the information aggregation unit.

Because the higher-level information processing unit 16 in this exemplary embodiment includes the segment selection function part 109, the higher-level information processing unit 16 can select a segment sequence by using the aggregated network information. That is to say, the higher-level information processing unit 16 can select a segment sequence to be subjected to path calculation by using the information aggregated thereby, and execute path calculation in accordance with the result of the selection. The selection of a segment sequence is performed in the same manner as in the case where the external WAN server 14 includes the segment selection function part 86 as described before. Therefore, the detailed description will be omitted.

After that, the fee management function part 108 determines a charged fee in consideration of the selection of the segment sequence by the segment selection function part 109 of the higher-level information processing unit 16 as well. Description of the charging process will be described because it has been made above.

Although this exemplary embodiment describes a case of aggregating network information of another segment without using the external WAN server 14, the external WAN server 14 and the information processing unit 11 may each include a segment selection function part according to the present invention. In this case, a segment sequence may be selected by either the information processing unit 11 or the external WAN server 14.

Further, in a case where the information processing unit 11 is configured to serve as the higher-level communication path instruction unit, the information processing unit 11 serves as the information aggregation unit. In this case, the information processing unit 11 is configured to include the segment selection function part.

### <Supplementary Notes>

The whole or part of the exemplary embodiments disclosed above can be described as the following supplementary notes. The outline of a communication system according to the present invention will be described below. However, the present invention is not limited to the following configurations.

### (Supplementary Note 1)

A communication system, wherein:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,

the communication system comprising:
an information aggregation unit aggregating a plurality of the network information acquired by information acquisition units of the respective segments;
a higher-level communication path instruction unit instructing establishment of a communication path passing through a plurality of networks in the networks of the respective segments by using the information aggregated by the information aggregation unit; and,
a charging unit determining a charged fee on a predetermined basis depending on the communication path passing through the plurality of networks, the communication path being established on instruction by the higher-level communication path instruction unit.

According to this configuration, a plurality of segments are formed, and the segments each include: a communication path instruction device instructing establishment of a communication path in a network; the network in which a communication path is established by the communication path instruction device; and an information acquisition unit acquiring network information of the network. In this state, information of the inside of the networks within the respective segments is aggregated by an information aggregation unit. Then, a higher-level communication path instruction unit can utilize the information aggregated by the information aggregation unit when establishing a communication path passing through a plurality of networks. Thus, the higher-level communication path instruction unit establishes a communication path passing through a plurality of segments. Moreover, at the time of the establishment, a charged fee is determined depending on the communication path established by the higher-level communication path instruction unit. Consequently, a telecommunications carrier can perform management of a communication path when it passes through segments by utilizing a facility of another provider (not the telecommunications carrier). As a result, the telecommunications carrier does not need to invest in the facility on its own. That is to say, it is possible to solve the problem that investment in communication facilities is huge because telecommunications carriers need to manage the communication facilities.

### (Supplementary Note 2)

The communication system according to Supplementary Note 1, wherein the charging unit determines a charged fee depending on a characteristic of the segments through which the communication path passes, the communication path being established by the higher-level communication path instruction unit.

According to this configuration, when determining a fee, a charging unit determines the fee depending on the characteristic of segments through which a communication path passes. Therefore, it is possible to change a fee determined by the charging unit in response to the characteristic of segments through which a communication path established by the higher-level communication path instruction unit passes. As a result, it is possible to determine a fee more depending on an established communication path.

### (Supplementary Note 3)

The communication system according to Supplementary Note 1 or 2, wherein the charging unit determines a charged fee depending on a number of the segments through which the communication path passes, the communication path being established by the higher-level communication path instruction unit.

According to this configuration, when determining a fee, the charging unit determines the fee depending on the number of segments through which a communication path passes. Therefore, it is possible to determine a fee more depending on an established communication path.

### (Supplementary Note 4)

The communication system according to any of Supplementary Notes 1 to 3, comprising a segment selection unit selecting the segments to be used for a communication path from among the plurality of segments on a basis of the information aggregated by the information aggregation unit, wherein:

the higher-level communication path instruction unit instructs establishment of a communication path passing through the networks of the respective segments selected by the segment selection unit; and

the charging unit determines a charged fee on a predetermined basis depending on the communication path passing through the networks of the respective segments selected by the segment selection unit, the communication path being established on instruction by the higher-level communication path instruction unit.

According to this configuration, the segment selection unit selects segments to be used for a communication path, and a communication path corresponding to the selection is established. Then, a fee is determined depending on the communication path established on the basis of the selection of the segments. Including the segment selection unit makes it possible to establish a communication path passing through a plurality of networks with more efficiency, for example, when a communication path needs to pass through many segments.

Then, it becomes possible to determine a fee corresponding to a more efficient communication path establishing means.

### (Supplementary Note 5)

The communication system according to Supplementary Note 4, wherein:

the segment selection unit selects the segments to be used for the communication path depending on communication service content information showing a content of a communication service set in advance; and

the charging unit determines a charged fee depending on the communication service content information.

According to this configuration, the segment selection unit selects segments to be used for a communication path depending on service content information. Then, a fee is determined depending on the service content information. Therefore, selection of segments appropriate to the content of a communication service is allowed, and determination of a fee appropriate for the selection of the segments is allowed.

### (Supplementary Note 6)

The communication system according to Supplementary Note 4 or 5, wherein the higher-level communication path instruction unit includes a function as the segment selection unit.

According to this configuration, the higher-level communication path instruction unit includes a function as the segment selection unit. Consequently, the higher-level communication path instruction unit can select segments to be used for a communication path on its own and then establish a communication path.

(Supplementary Note 7) The communication system according to any of Supplementary Notes 1 to 6, wherein one or more of a plurality of communication path instruction devices provided in the plurality of segments, respectively, include a function as the higher-level communication path instruction unit.

According to this configuration, the communication path instruction device included by each of the networks can be used as the higher-level communication path instruction device. Therefore, it is possible to establish a communication path passing through a plurality of networks without providing a higher-level communication path instruction device.

### (Supplementary Note 8)

An information processing device used in a state that:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,

the information processing device comprising a charging unit determining a charged fee on a predetermined basis depending on a communication path passing through a plurality of the networks, the communication path being established by using information obtained by aggregating a plurality of the network information acquired by information acquisition units of the respective segments.

### (Supplementary Note 9)

The information processing device according to Claim 8, the information processing device acquiring information on a characteristic of the segments through which the established communication path passes,

the information processing device comprising a charging unit determining a charged fee depending on information on a characteristic of the segments being passed through.

### (Supplementary Note 10)

A charging method in a state that:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,

the charging method comprising:
aggregating the network information from the networks of the respective segments;
instructing establishment of a communication path passing through a plurality of the networks by using the aggregated network information; and
determining a charged fee on a predetermined basis depending on the communication path passing through the networks.

### (Supplementary Note 11)

The charging method according to Claim 10, comprising:

acquiring information on a characteristic of the segments through which the established communication path passes; and

determining a charged fee depending on the information on the characteristic of the segments being passed through.

### (Supplementary Note 12)

A computer program in a state that:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,

the computer program comprising instructions for causing an information processing device to realize a charging unit determining a charged fee on a predetermined basis depending on a communication path passing through a plurality of networks, the communication path being established by using information obtained by aggregating a plurality of the network information acquired by information acquisition units of the respective segments.

The program described in the exemplary embodiments and Supplementary Notes is stored in a storage device or recorded on a computer-readable recording medium. For example, the recording medium is a portable medium such as a flexible disk, an optical disk, a magneto-optical disk, and a semiconductor memory.

Although the present invention has been described above referring to the exemplary embodiments, the present invention is not limited to the exemplary embodiments described above. The configurations and details of the present invention may be changed in various manners that can be understood by one skilled in the art within the scope of the present invention.

The present invention is based upon and claims the benefit of priority from Japanese patent application No. 2013-152439, filed on Jul. 23, 2013, the disclosure of which is incorporated herein in its entirety by reference.

### DESCRIPTION OF NUMERALS

11 information processing unit
12 network
13 terminal device
14 external WAN server
15 network connection device
16 higher-level information processing unit
21 information processing device
22 network
31 OpenFlow switch
41 virtual machine control function part
42 administrator function part
43 stateful proxy function part
44 DNS function part
45 OpenFlow controller function part
46 policy server function part
47 flow table server function part
51 communication part
52 virtual machine control part
53 virtual machine DB
61 arithmetic part
62 input/output part
63 storage part
64 communication part
65 acquisition part
71 transfer control part
72 flow table DB
81 DNS function part
82 topology information DB
83 flow table information DB
84 policy information DB
85 network selection function part
86 congestion/failure information DB
91 flow table
101 virtual machine control function part
102 administrator function part
103 stateful proxy function part
104 DNS function part
105 OpenFlow controller function part
106 policy server function part
107 flow table server function part
108 fee management function part
109 segment selection function part
111 communication part
112 fee calculation part
113 fee DB

What is claimed is:

1. A communication system, wherein:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,
the communication system comprising:
an information aggregation unit aggregating a plurality of the network information acquired by information acquisition units of the respective segments;
a higher-level communication path instruction unit instructing establishment of a communication path passing through a plurality of networks in the networks of the respective segments by using the information aggregated by the information aggregation unit; and,
a charging unit determining a charged fee on a predetermined basis depending on the communication path passing through the plurality of networks, the communication path being established on instruction by the higher-level communication path instruction unit.

2. The communication system according to claim 1, wherein the charging unit determines a charged fee depending on a characteristic of the segments through which the communication path passes, the communication path being established by the higher-level communication path instruction unit.

3. The communication system according to claim 1, wherein the charging unit determines a charged fee depending on a number of the segments through which the communication path passes, the communication path being established by the higher-level communication path instruction unit.

4. The communication system according to claim 1, comprising a segment selection unit selecting the segments to be used for a communication path from among the plurality of segments on a basis of the information aggregated by the information aggregation unit, wherein:
the higher-level communication path instruction unit instructs establishment of a communication path passing through the networks of the respective segments selected by the segment selection unit; and
the charging unit determines a charged fee on a predetermined basis depending on the communication path passing through the networks of the respective segments selected by the segment selection unit, the communication path being established on instruction by the higher-level communication path instruction unit.

5. The communication system according to claim 4, wherein:
the segment selection unit selects the segments to be used for the communication path depending on communication service content information showing a content of a communication service set in advance; and
the charging unit determines a charged fee depending on the communication service content information.

6. The communication system according to claim 4, wherein the higher-level communication path instruction unit includes a function as the segment selection unit.

7. The communication system according to claim 1, wherein one or more of a plurality of communication path instruction devices provided in the plurality of segments, respectively, include a function as the higher-level communication path instruction unit.

8. An information processing device used in a state that:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,
the information processing device comprising a charging unit determining a charged fee on a predetermined basis depending on a communication path passing through a plurality of the networks, the communication path being established by using information obtained by aggregating a plurality of the network information acquired by information acquisition units of the respective segments.

9. The information processing device according to claim 8, the information processing device acquiring information on a characteristic of the segments through which the established communication path passes,
the information processing device comprising a charging unit determining a charged fee depending on information on a characteristic of the segments being passed through.

10. A charging method in a state that:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,
the charging method comprising:
aggregating the network information from the networks of the respective segments;
instructing establishment of a communication path passing through a plurality of the networks by using the aggregated network information; and
determining a charged fee on a predetermined basis depending on the communication path passing through the networks.

11. The charging method according to claim 10, comprising:
acquiring information on a characteristic of the segments through which the established communication path passes; and
determining a charged fee depending on the information on the characteristic of the segments being passed through.

12. A non-transitory computer-readable medium storing a computer program in a state that:
a plurality of segments are formed;
the plurality of segments each include: a communication path instruction device instructing establishment of a communication path in a network; the network in which a communication path is established by the communication path instruction device; and an information acquisition unit acquiring network information of the network; and
networks of the respective segments are connected to each other via a network connection device,
the computer program comprising instructions for causing an information processing device to realize a charging unit determining a charged fee on a predetermined basis depending on a communication path passing through a plurality of networks, the communication path being established by using information obtained by aggregating a plurality of the network information acquired by information acquisition units of the respective segments.
